(19) United States
(12) Patent Application Publication
(10) Pub. No.: US 2022/0375055 A1
(43) Pub. Date: Nov. 24, 2022

(54) SETTING SYSTEM, SETTING METHOD, AND PROGRAM

(71) Applicant: Panasonic Intellectual Property Management Co., Ltd., Osaka (JP)

(72) Inventors: Yu MOROOKA, Shiga (JP); Hidetaka MORIMITSU, Osaka (JP); Kimiya IKUSHIMA, Osaka (JP); Masaaki OCHI, Osaka (JP); Kazuma HARAGUCHI, Osaka (JP)

(21) Appl. No.: 17/782,032

(22) PCT Filed: Oct. 27, 2020
(86) PCT No.: PCT/JP2020/040292

§ 371 Date: Jun. 2, 2022

(30) Foreign Application Priority Data
Dec. 3, 2019 (JP) 2019-219158
Dec. 10, 2019 (JP) 2019-223240

(51) Int. Cl. G06T 7/00; G06V 10/40; G06V 10/764; G01N 21/88

(52) U.S. Cl. CPC G06T 7/001; G06V 10/40; G06V 10/764; G01N 21/8851; G06T 2207/30108; G01N 2021/8887

(57) ABSTRACT

An extraction unit acquires a first difference between a non-defective product image, covering a non-defective product sample, and a reference model and a second difference between a defective product image, covering a defective product sample, and the reference model. A extraction unit extracts, as a potential defect, either the first difference or the second difference, whichever satisfies a particular condition. A calculation unit calculates at least one feature quantity with respect to the potential defect extracted by the extraction unit. When the defective product sample includes a plurality of defective product samples and respective feature quantities of the potential defects extracted from the defective product samples have multiple different values, the calculation unit specifies at least one of the feature quantities that has an Nth largest one of the multiple different values as an indicator. The presentation unit presents the indicator specified by the calculation unit.

### TECHNICAL FIELD

The present disclosure generally relates to a setting system, a setting method, and a program. More particularly, the present disclosure relates to a setting system, setting method, and program for use in an appearance inspection machine for inspecting the appearance of a target.

### BACKGROUND ART

Patent Literature 1 discloses an appearance inspection machine for inspecting the surface appearance of an object under test (target). The appearance inspection machine of Patent Literature 1 determines a threshold value (decision threshold value) based on the statistical quantity of differential quantity data of multiple points on the object under test. Patent Literature 2 discloses a defect inspection apparatus, which plots, on a graph, the distribution of potential defects on an object under test to set a threshold value (decision threshold value).

### CITATION LIST

### Patent Literature

Patent Literature 1: JP H04-107946 A

Patent Literature 2: WO 2016/092614 A1

Patent Literature 3: JP 2007-3326 A

Patent Literature 4: WO 2015/087440 A1

### SUMMARY OF INVENTION

In general, an appearance inspection machine requires a threshold parameter for determining the object under test to be a defective product. The parameter needs to be set appropriately with respect to a complicated distribution (such as the one shown in FIG. 3A as will be described later) in which potentially defective samples derived from both defective products and non-defective products are included in mixture. Particularly, in the case of high-mix low-volume production, the inspection targets are changed frequently. Thus, in such a situation, the parameter would need to be set more frequently.

The appearance inspection machine of Patent Literature 1 is designed to be applied to low-mix high-volume production, and therefore, requires a lot of samples and man-hours to determine the threshold value. Thus, the appearance inspection machine of Patent Literature 1 is not suitably applicable to appearance inspection for high-mix low-volume production.

The defect inspection apparatus of Patent Literature 2 needs to selectively acquire, in advance, defect information about every potentially defective sample included in the entire work, i.e., determine in advance whether or not a given product should be regarded as a defective one, thus imposing heavy burden on the worker.

An object of the present disclosure to provide a setting system, a setting method, and a program, all of which are configured or designed to set a decision threshold value suitably applicable to appearance inspection for high-mix low-volume production.

A setting system according to an aspect of the present disclosure is designed for use in an appearance inspection machine to inspect appearance of a plurality of targets. The setting system includes an extraction unit, a calculation unit, and a presentation unit. The extraction unit acquires a first difference between a non-defective product image, covering a non-defective product sample to be classified as a non-defective product among the plurality of targets, and a reference model. The extraction unit also acquires a second difference between a defective product image, covering a defective product sample to be classified as a defective product among the plurality of targets, and the reference model. The extraction unit extracts, as a potential defect, either the first difference or the second difference, whichever satisfies a particular condition. The calculation unit calculates at least one feature quantity with respect to the potential defect that has been extracted by the extraction unit. When the defective product sample includes a plurality of defective product samples and respective feature quantities of the potential defects extracted from the plurality of defective product samples have multiple different values, the calculation unit specifies at least one of the feature quantities that has an N^{th} largest one (where N is a natural number) of the multiple different values as an indicator. The presentation unit presents the indicator specified by the calculation unit.

A setting method according to another aspect of the present disclosure is applicable to an appearance inspection machine to inspect appearance of a plurality of targets. The setting method includes an extraction step, a calculation step, and a presentation step. The extraction step includes acquiring a first difference between a non-defective product image, covering a non-defective product sample to be classified as a non-defective product among the plurality of targets, and a reference model. The extraction step also includes acquiring a second difference between a defective product image, covering a defective product sample to be classified as a defective product among the plurality of targets, and the reference model. The extraction step further includes extracting, as a potential defect, either the first difference or the second difference, whichever satisfies a particular condition. The calculation step includes calculating at least one feature quantity with respect to the potential defect extracted in the extraction step. The calculation step includes specifying, when the defective product sample includes a plurality of detective product samples and respective feature quantities of the potential defects extracted from the plurality of defective product samples have multiple different values, at least one of the feature quantities that has an N^{th} largest one (where N is a natural number) of the multiple different values as an indicator. The presentation step includes presenting the indicator specified in the calculation step.

A program according to still another aspect of the present disclosure is designed to cause one or more processors to perform the setting method described above.

### BRIEF DESCRIPTION OF DRAWINGS

FIG. 1 illustrates a configuration for a setting system according to a first embodiment;

FIG. 2 is a flowchart showing how the setting system operates when setting a decision threshold value;

FIG. 3A is an exemplary graph to be presented by the setting system;

FIG. 3B is another exemplary graph to be presented by the setting system;

FIG. 4A is an exemplary graph to be presented by the setting system;

FIG. 4B is another exemplary graph to be presented by the setting system;

FIG. 5 is a flowchart showing how the setting system operates when determining whether or not the given target is a go or a no-go;

FIG. 6A illustrates an exemplary first display region presented by the setting system;

FIG. 6B illustrates an exemplary second display region presented by the setting system;

FIG. 6C illustrates an exemplary third display region presented by the setting system;

FIG. 6D illustrates an exemplary fourth display region presented by the setting system;

FIG. 7A illustrates another exemplary first display region presented by the setting system;

FIG. 7B illustrates another exemplary second display region presented by the setting system;

FIG. 7C illustrates another exemplary third display region presented by the setting system;

FIG. 7D illustrates another exemplary fourth display region presented by the setting system;

FIG. 8 is an exemplary graph to be presented by a setting system according to a first variation of the first embodiment;

FIG. 9A illustrates an exemplary first display region presented by the setting system;

FIG. 9B illustrates an exemplary second display region presented by the setting system;

FIG. 9C illustrates an exemplary fourth display region presented by the setting system;

FIG. 10A is an exemplary graph to he presented by a setting system according to a second variation of the first embodiment;

FIG. 10B is another exemplary graph to be presented by the setting system;

FIG. 11 illustrates a configuration for a setting system and appearance inspection machine according to a second embodiment;

FIG. 12 illustrates an exemplary settings window of the setting system;

FIG. 13 illustrates a default state of the settings window according to a first exemplary operation of the setting system;

FIG. 14 illustrates a first state of the settings window according to the first exemplary operation of the setting system;

FIGS. 15A-15D illustrate how indicators make transitions with respect to an overall image on the settings window according to the first exemplary operation of the setting system;

FIG. 16 illustrates a second state of the settings window according to the first exemplary operation of the setting system;

FIG. 17 illustrates a third state of the settings window according to the first exemplary operation of the setting system;

FIG. 18 illustrates a fourth state of the settings window according to the first exemplary operation of the setting system;

FIG. 19 illustrates a first state of a settings window according to a second exemplary operation of the setting system;

FIG. 20 illustrates a second state of the settings window according to the second exemplary operation of the setting system;

FIG. 21 illustrates a third state of the settings window according to the second exemplary operation of the setting system;

FIG. 22 illustrates a fourth state of the settings window according to the second exemplary operation of the setting system;

FIG. 23 illustrates a first state of a settings window according to a third exemplary operation of the setting system;

FIG. 24 illustrates a second state of the settings window according to the third exemplary operation of the setting system;

FIG. 25 illustrates a third state of the settings window according to the third exemplary operation of the setting system;

FIG. 26 illustrates a fourth state of the settings window according to the third exemplary operation of the setting system;

FIG. 27 illustrates a fifth state of the settings window according to the third exemplary operation of the setting system;

FIG. 28 illustrates a sixth state of the settings window according to the third exemplary operation of the setting system;

FIG. 29 illustrates a first state of a settings window according to a fourth exemplary operation of the setting system;

FIG. 30 illustrates an exemplary settings window of a setting system according to a first variation of the second embodiment;

FIG. 31 illustrates an exemplary setting member for use in a setting system according to a second variation of the second embodiment;

FIG. 32 illustrates an exemplary setting member for use in a setting system according to a third variation of the second embodiment;

FIG. 33 illustrates an exemplary settings window of a setting system according to a fifth variation of the second embodiment; and

FIG. 34 illustrates an exemplary settings window of a setting system according to a sixth variation of the second embodiment.

### DESCRIPTION OF EMBODIMENTS

### First Embodiment

A setting system according to a first embodiment will be described. Note that the first embodiment and its variations to be described below are only exemplary ones of various embodiments and their variations of the present disclosure and should not be construed as limiting. Rather, the first embodiment and its variations may be readily modified in various manners depending on a design choice or any other factor without departing from the true spirit and scope of the present disclosure.

### (1) Overview of Setting System

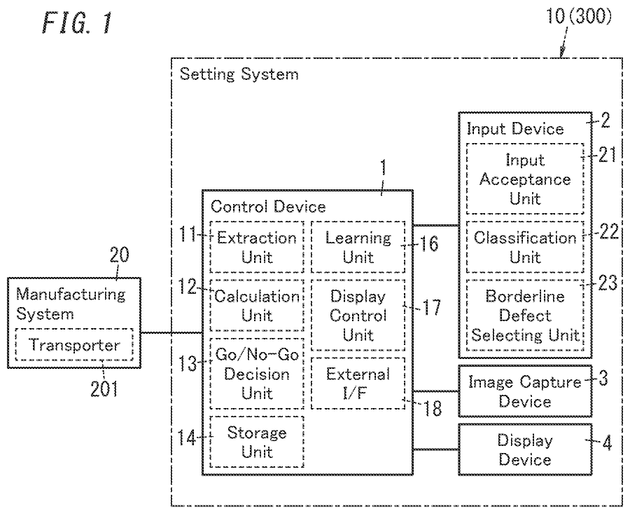

Next, an overview of a setting system 10 according to the first embodiment will be described with reference to FIG. 1.

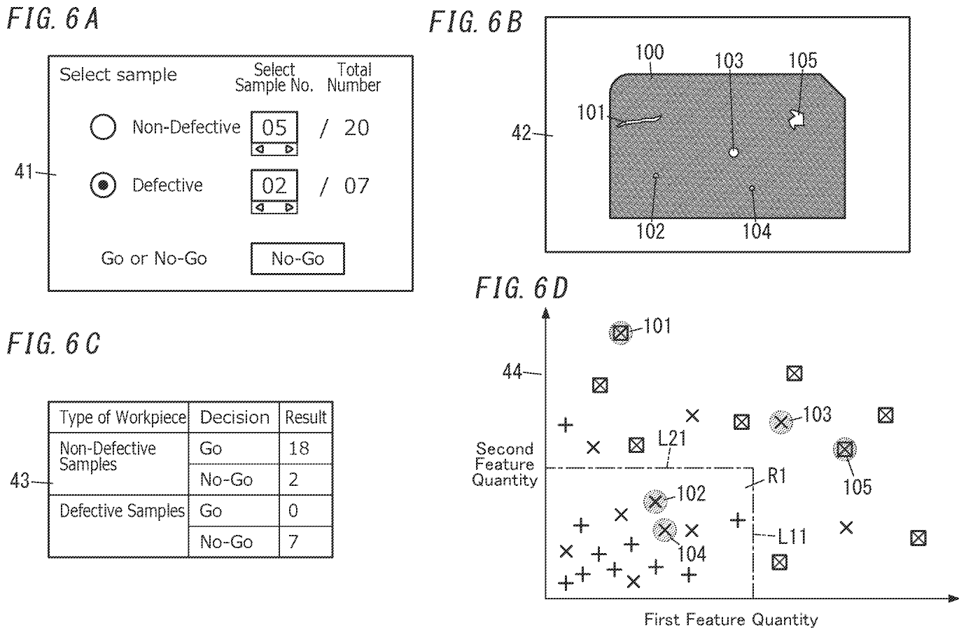

The setting system 10 according to the first embodiment may be used in, for example, an appearance inspection machine 300. The appearance inspection machine 300 is used to inspect the appearance of a plurality of targets 100 (see FIG. 6B). The plurality of targets 100 may be, for example, chip components such as resistors, capacitors, and inductors. Note that the targets 100 do not have to be chip components but may also be circuit boards, sheet metal parts such as a leaf spring, or resin molded products such as covers. The setting system 10 is used to set a decision threshold value for the appearance inspection machine 300 to determine whether or not the plurality of targets 100 are non-defective products. In the first embodiment, the appearance inspection machine 300 includes the setting system 10.

Recently, high-mix low-volume production has become increasingly important year after year. According to the low-mix high-volume production that was the norm in the past, an enormous number of targets (i.e., objects under test) need to be subjected to appearance inspection at a time, thus requiring setting an appropriate decision threshold value through, for example, statistical processing to reduce detection errors. Setting the decision threshold value thus requires a lot of samples and man-hours.

Meanwhile, the high-mix low-volume production depends heavily on naked eye inspection because the targets of the appearance inspection are changed frequently. Thus, the inspection burden imposed on the worker should be lightened. To overcome this problem, a setting system 10 with the ability to set a decision threshold value suitably applicable to naked eye inspection for high-mix low-volume production will be presented in order to lighten the naked eye inspection burden on the worker.

The setting system 10 includes an extraction unit 11, a calculation unit 12, and a display device 4 serving as a presentation unit as shown in FIG. 1.

The extraction unit 11 acquires a first difference between a non-defective product image, covering a non-defective product sample to be classified as a non-defective product among the plurality of targets 100 (see FIG. 6B) and a reference model. The extraction unit 11 also acquires a second difference between a defective product image, covering a defective product sample to be classified as a defective product among the plurality of targets 100 (see FIG. 6B) and the reference model. Then, the extraction unit 11 extracts, as a potential defect, either the first difference or the second difference, whichever satisfies a particular condition. As used herein, the “reference model” refers to a comparative model used as a reference for extracting the potential defect (imperfect part) from each of the plurality of targets 100. In this case, the extraction unit 11 compares the non-defective product image and the defective product image with the reference model. Thus, the reference model may be an image itself or may also be a statistical model covering the dispersion of the objects under test. Also, as used herein, the “particular condition” refers to the relation in magnitude between the first difference, the second difference, and an extraction threshold value. Either the first difference or the second difference which is equal to or greater than the extraction threshold value is the difference that satisfies the predetermined condition. Furthermore, as used herein, the “extraction threshold value” refers to a threshold value for binarizing the first difference and the second difference.

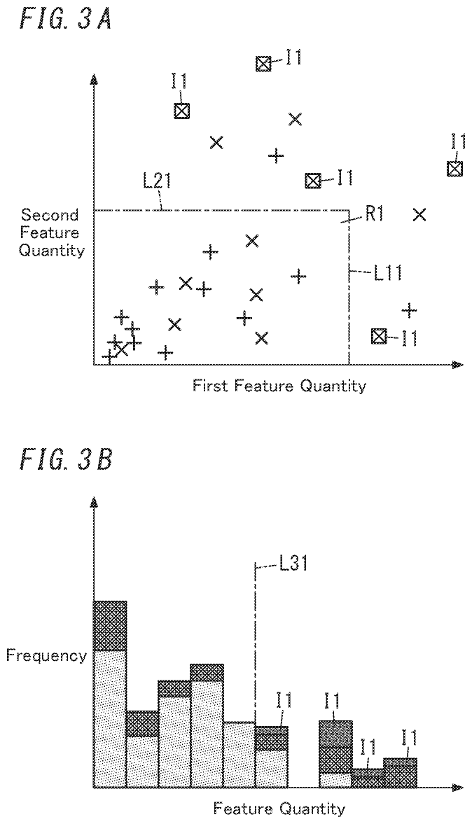

The calculation unit 12 calculates at least one feature quantity with respect to the potential defect extracted by the extraction unit 11. As used herein, examples of the “feature quantity” include the area value, major diameter (length), and luminance of the potential defect. When the defective product sample includes a plurality of defective product samples and respective feature quantities of the potential defects extracted from the plurality of defective product samples have multiple different values, the calculation unit 12 specifies at least one of the feature quantities that has an N^{th} largest one of the multiple different values as an indicator I1 (see FIG. 3A), where N is a natural number equal to or greater than 1. In the first embodiment, the calculation unit 12 calculates two feature quantities (which will be hereinafter referred to as a “first feature quantity” and a “second feature quantity,” respectively) with respect to each potential defect and specifies a feature quantity with the largest value as the indicator I1 with respect to each of the two feature quantities.

The display device 4 (presentation unit) presents (displays) the indicator I1 specified by the calculation unit 12.

In the setting system 10 according to the first embodiment, the indicator I1 specified by the calculation unit 12 is displayed (presented) on the display device 4 (presentation unit) and the decision threshold value may be set based on the indicator I1. In addition, the decision threshold value may also be specified even when the number of samples is small. Thus, the setting system 10 according to the first embodiment may set a decision threshold value suitably applicable to appearance inspection for high-mix low-volume production. In addition, at least one of the potential defects of each defective product sample is always included in the indicator I1. Thus, every defective product sample may be determined to be detective with reliability by setting the decision threshold value based on the indicator I1.

### (2) Details of Setting System

Next, the setting system 10 according to the first embodiment will be described in further detail with reference to FIG. 1.

As shown in FIG. 1, the setting system 10 according to the first embodiment includes a control device 1, an input device 2, an image capture device 3, and a display device 4. Also, the setting system 10 is connected to a manufacturing system 20 as shown in FIG. 1.

### (2.1) Control Device

The control device 1 may be, for example, a personal computer. As shown in FIG. the control device 1 includes an extraction unit 11, a calculation unit 12, a go/no-go decision unit 13, and a storage unit 14. In addition, the control device 1 further includes a learning unit 16, a display control unit 17, and an external interface 18. Note that in FIG. 1, the external interface 18 is abbreviated as “external I/F 18” and will be hereinafter referred to as such.

The control device 1 is implemented as a computer system including a processor and a memory. The computer system performs the function of the control device 1 by making the processor execute an appropriate program. The program may be stored in advance in the memory. Alternatively, the program may also be downloaded via a telecommunications line such as the Interne or distributed after having been stored in a non-transitory storage medium such as a memory card.

The external I/F 18 is a connection interface that connects the control device 1, the input device 2, the image capture device 3. and the display device 4. That is to say, the control device 1 may be connected to each of the input device 2, the image capture device 3, and the display device 4 via the external I/F 18. In addition, the control device 1 may also be connected to the manufacturing system 20 via the external I/F 18.

The extraction unit 11 is configured to extract a potential defect from a non-defective product image and a defective product image. As used herein, the non-defective product image is an image covering a non-defective product sample classified as a non-defective product among the plurality of targets 100 and the defective product image is an image covering a defective product sample classified as a defective product (defective article) among the plurality of targets 100. As used herein, the “potential defect” refers to a part that potentially constitutes a defect on the surface of the target 100. The extraction unit 11 compares the non-defective product image with the reference model to acquire a first difference as the difference between the non-defective product image and the reference model. In addition, the extraction unit 11 also compares the defective product image with the reference model to acquire a second difference as the difference between the defective product image and the reference model. Then, the extraction unit 11 extracts either the first difference or the second difference, whichever satisfies a particular condition.

Specifically, the extraction unit 11 acquires the difference between the non-defective product image and the reference model on a pixel-by-pixel basis and compares the difference thus acquired with an extraction threshold value on a pixel-by-pixel basis. Then, the extraction unit 11 turns adjacent ones of the pixels that are equal to or greater than the extraction threshold value into a group and extracts the group of adjacent pixels as the potential defect. Likewise, the extraction unit 11 acquires the difference between the defective product image and the reference model on a pixel-by-pixel basis and compares the difference thus acquired with the extraction threshold value on a pixel-by-pixel basis. Then, the extraction unit 11 turns adjacent ones of the pixels that are equal to or greater than the extraction threshold value into a group and extracts the group of adjacent pixels as the potential defect. Optionally, those pixels that are equal to or greater than the extraction threshold value may be subjected to expansion or contraction processing as appropriate before being turned into a group of pixels.

The calculation unit 12 calculates at least one feature quantity with respect to each of the potential defects that have been extracted by the extraction unit 11. Then, the calculation unit 12 specifies a feature quantity with the largest value, among the feature quantities of the potential defects extracted from the defective product sample, as an indicator I1 (see FIG. 3A). For example, if the feature quantity is the area value of the potential defect, then the calculation unit 12 specifies the feature quantity of a potential defect with the largest area value, among the plurality of potential defects, as the indicator I1. In the first embodiment, the feature quantity includes a first feature quantity and a second feature quantity. That is to say, in the setting system 10 according to the first embodiment, the calculation unit 12 calculates two feature quantities (namely, the first feature quantity and the second feature quantity) with respect to each of the potential defects that have been extracted by the extraction unit 11. The first feature quantity may be, for example, the area value of the potential defect. The second feature quantity may be, for example, the major diameter (length) of the potential defect. In the setting system 10 according to the first embodiment, two feature quantities are calculated for each potential defect, and therefore, the calculation unit 12 specifies one or two indicators I1 with respect to each target 100.

The go/no-go decision unit 13 is configured to make a go/no-go decision with respect to each of the plurality of targets 100. Specifically, the go/no-go decision unit 13 determines each target 100 to be a go or a no-go by seeing if the feature quantity of the potential defect is greater than a decision threshold value in each target 100. For example, when finding the feature quantity of the potential defect extracted from the target 100 greater than the decision threshold value (i.e., when finding the feature quantity falling outside of a first decision range R1 (see FIG. 3A) specified by the decision threshold value), the go/no-go decision unit 13 determines the target 100 to be a “no-go” (defective). In this case, in a situation where a plurality of potential defects are extracted from the target 100, when finding the feature quantity of at least one potential defect greater than the decision threshold value, the go/no-go decision unit 13 may determine the target 100 to be a “no-go.” Alternatively, in such a situation, when finding the number of feature quantities greater than the decision threshold value a predetermined number or more, the go/no-go decision unit 13 may determine the target 100 to be a “no-go.” In the first embodiment, when finding the feature quantity of at least one potential defect greater than the decision threshold value, the go/no-go decision unit 13 determines the target 100 to be a “no-go.”

On the other hand, When finding the feature quantity of the potential defect extracted from the target 100 equal to or less than the decision threshold value (i.e., when finding the feature quantity falling within the first decision range R1), the go/no-go decision unit 13 determines the target 100 to be a “go” (non-defective). In this case, in a situation where a plurality of potential defects are extracted from the target 100, when finding the feature quantity of at least one potential defect equal to or less than the decision threshold value, the go/no-go decision unit 13 may determine the target 100 to be a “go.” Alternatively, in such a situation, when finding the feature quantity of every potential defect equal to or less than the decision threshold value, the go/no-go decision unit 13 may determine the target 100 to be a “go.” Still alternatively, in such a situation, when finding the number of potential defects equal to or greater than the decision threshold value a predetermined number or less, the go/no-go decision unit 13 may determine the target 100 to be a “go.” In the first embodiment, when finding the feature quantity of every potential defect equal to or less than the decision threshold value, the go/no-go decision unit 13 determines the target 100 to be a “go.” In this case, the decision threshold value is set such that the indicator I1 specified by the calculation unit 12 falls outside of the first decision range R1 (to be described later) defined by the decision threshold value. It will be described in detail later in the “(3.1) Setting decision threshold value” section how to set the decision threshold value.

The storage unit 14 may be, for example, a hard disk drive (HDD). The storage unit 14 stores the reference model as a result of learning made by the learning unit 16. The storage unit 14 stores an extraction threshold value and the decision threshold value for use when appearance inspection is performed by the appearance inspection machine 300. The extraction threshold value is a threshold value for extracting (binarizing) a potential defect from the target 100. The decision threshold value is a threshold value for determining whether the target 100 is a go or a no-go. The storage unit 14 stores images of objects under test. The images of objects under test are images (i.e., non-defective product images and defective product images) of samples (i.e., non-defective product samples and defective product samples) captured by the image capture device 3 when the decision threshold value is set. The images of the objects under test are stored in the storage unit 14 to be classified into non-defective product samples and defective product samples.

The non-defective product images and defective product images (i.e., images of objects under test) captured by the image capture device 3 and identification information entered through the input device 2 are associated with each other. As used herein, the identification information refers to information for identifying non-defective product samples and defective product samples (such as sample numbers) from each other. Thus, the storage unit 14 stores the images of objects under test and the identification information in association with each other.

The learning unit 16 is configured to produce the reference model. Specifically, the learning unit 16 performs, based on N non-defective product images (where N is a natural number) captured by the image capture device 3, statistical processing on the pixel-by-pixel luminance values, thereby obtaining average and variance values on a pixel-by-pixel basis. That is to say, in the first embodiment, the reference model is a statistical model with average and variance values of the luminance obtained on a pixel-by-pixel basis. In this case, the learning unit 16 sets the extraction threshold value based on the reference model. Specifically, the learning unit 16 sets, based on the average and variance values of the luminance in the luminance distribution of the reference model, a tolerance range of the luminance and regards the tolerance range of the luminance as an extraction threshold value. Also, when setting the extraction threshold value based on a single non-defective product image, the learning unit 16 directly specifies the tolerance range of luminance.

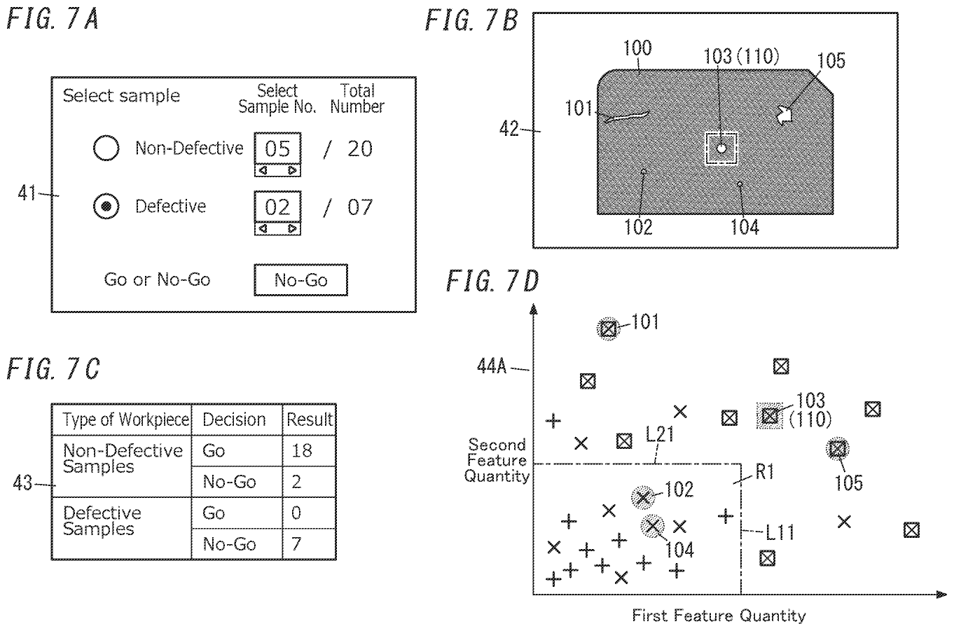

The display control unit 17 is configured to control the display device 4. The display control unit 17 outputs an image signal to the display device 4, thereby making the display device 4 display the images such as the ones shown in FIGS. 6A-6D and FIGS. 7A-7D.

### (2.2) Input Device

The input device 2 is an input interface for inputting information to the control device 1. The input device 2 is connected to the control device 1 via the external I/F 18. The input device 2 may include, for example, a keyboard and a mouse. This allows the user (worker) to enter information with respect to the control device 1 by operating the keyboard and the mouse.

As shown in FIG. 1, the input device 2 includes an input acceptance unit 21, a classification unit 22, and a borderline defect selecting unit 23.

The input acceptance unit 21 is configured to accept the decision threshold value entered by the user. Specifically, the user may enter, with respect to the graph (see FIG. 6D) displayed on the display device 4, a first threshold line L11 and a second threshold line L21 (see FIG. 3A) that define the decision threshold value by using a mouse, for example. At this time, the user enters the first threshold line L11 and the second threshold line L21 such that the indicator I1 does not fall within the first decision range R1 (see FIG. 3A) in the graph displayed on the display device 4. That is to say, the input acceptance unit 21 accepts the decision threshold value entered by the user based on the indicator I1 presented (or displayed) on the presentation unit (display device 4).

The classification unit 22 classifies the given image as either a non-defective product image or a defective product image. In other words, by using the classification unit 22, the user classifies an image of a non-defective product sample to be determined to be a “go” as a non-detective product image and classifies an image of a defective product sample to be determined to be a “no-go” as a defective product image.

The borderline defect selecting unit 23 is configured to select, from the potential defects of the defective product sample, a borderline defect that allows the detective product sample to be determined to be a defective product. That is to say, the “borderline defect” herein refers to a defect that defines a boundary (border line) at which the target 100 may be determined to be a “no-go.” The borderline defect selecting unit 23 selects, in a state where an image of an object under test covering the target 100 (sample) is displayed on the display device 4 as shown in FIG. 7B, a borderline defect 110 by having the user chose at least one potential defect from the potential defects 101-105 of the target 100. In FIG. 7B, the borderline defect selecting unit 23 selects the potential defect 103 as the borderline defect 110 by having the user choose the potential defect 103. The borderline defect 110 selected by the borderline defect selecting unit 23 is displayed on the display device 4 as shown in FIG. 7D.

### (2.3) Image Capture Device

The image capture device (image capturing unit) 3 is a camera including an image sensor for capturing an image of a subject (target 100). The camera may be a camcorder or a still camera. Also, the camera may be configured to capture a color image or a monochrome image, whichever is appropriate.

The image capture device 3 is configured to capture an image of an image capturing area that is set to cover the target 100. The image capture device 3 captures a non-defective product image covering a non-defective product sample to be classified as a non-defective product among the plurality of targets 100 and a defective product image covering a defective product sample to be classified as a defective product among the plurality of targets 100. That is to say, the setting system 10 according to the first embodiment further includes an image capturing unit (image capture device 3) for capturing a non-defective product image and a defective product image.

The image sensor is a two-dimensional image sensor such as a CCD (charge coupled device) image sensor or a CMOS (complementary metal-oxide semiconductor) image sensor. The image capture device 3 has the light, coming from the subject, imaged on an image capturing plane (photosensitive plane) of the image sensor by an optical system such as a lens and makes the image sensor photoelectrically transduce the light coming from the subject into an electrical signal. Then, the image capture device 3 provides an output signal of the image sensor as an image signal to the control device 1.

In this case, in the setting system 10 according to the first embodiment, the manufacturing system 20 and the image capture device 3 may be connected to each other via the external I/F 18 of the control device 1. When a go/no-go decision should be made on the target 100, the image capture device 3 captures an image of an image capturing area, covering the target 100, in accordance with an image capture command signal from the manufacturing system 20. The image capture command signal is output from the manufacturing system 20 to the setting system 10 (appearance inspection machine 300) at the timing when the target 100 is transported from the manufacturing system 20 to the setting system 10.

On the other hand, when the decision threshold value should be set, the user may enter an image capture command via the input device 2, for example, thereby making the image capture device 3 capture an image capturing area covering the target 100 (sample).

### (2.4) Display Device

The display device (presentation unit) 4 may be a liquid crystal display, for example. The display device 4 has first to fourth display regions 41-44 as shown in FIGS. 6A-6D. In other words, the display device 4 is configured to display at least the first to fourth display regions 41-44. The first to fourth display regions 41-44 will be described in detail later in the “(4.1) First exemplary display” section.

### (2.5) Manufacturing System

The manufacturing system 20 is a part manufacturing system for manufacturing, for example, chip parts. The manufacturing system 20 includes a transporter 201 for transporting chip parts (targets 100) manufactured. The transporter 201 may be a parts feeder, for example. The transporter 201 transports the chip parts manufactured to the setting system 10 (appearance inspection machine 300).

The manufacturing system 20 outputs an image capture command signal to the image capture device 3 at the timing when the transporter 201 transports the chip parts to the setting system 10.

### (3) Operation

Next, it will be described how the setting system 10 operates.

### (3.1) Setting Decision Threshold Value

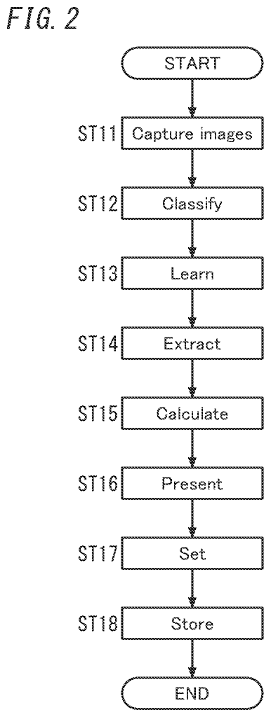

First, it will be described with reference to FIGS. 2, 3A, and 3B how the setting system 10 operates when setting the decision threshold value.

The image capture device 3 continuously captures images of an image capturing area, covering the targets 100 (samples) on the manufacturing line, in synch with the manufacturing line (in Step ST11). In the meantime, identification information is automatically assigned to the samples. The identification information may be serial numbers, for example.

The user classifies, using the classification unit 22 of the input device 2, each of the series of images of the objects under test, captured by the image capture device 3, into either a non-defective product image or a defective product image (in Step ST12).

The learning unit 16 creates a reference model based on N non-defective product images (where N is a natural number) acquired in the processing steps ST11 and ST12 (in Step ST13). In addition, the learning unit 16 also sets an extraction threshold value based on the average and variance values of luminance in the luminance distribution of the reference model.

The extraction unit 11 acquires the first difference between the non-defective product image and the reference model or the second difference between the defective product image and the reference model and compares either the first difference or the second difference with the extraction threshold value, thereby extracting a potential defect (in Step ST14).

The calculation unit 12 calculates a first feature quantity and a second feature quantity with respect to the potential defect extracted by the extraction unit 11 (in Step ST15). Also, if the target 100 is a defective product sample, the calculation unit 12 specifies a feature quantity with the largest value, among a plurality of feature quantities included in the potential defect, as an indicator I1 (see FIG. 3A). In the setting system 10 according to the first embodiment, the indicator I1 is specified with respect to each of the first feature quantity and the second feature quantity.

The display device 4 displays (presents), in accordance with an image signal supplied from a display control unit 17 of the control device 1, a graph (see FIG. 3A) including the first and second feature quantities calculated by the calculation unit 12 and the indicator I1 (in Step ST16). That is to say, the display device 4 serving as the presentation unit presents the feature quantities of the potential defects as a graph.

The user sets, on the graph displayed on the display device 4, the decision threshold value by using the input device 2 (in Step ST17). Specifically, the user sets the decision threshold value by entering a first threshold line L11 and a second threshold line L12 to the graph. At this time, the user enters the first threshold line L11 and the second threshold line L12 such that the indicator I1 does not fall within a first decision range R1 defined by the first threshold line L11 and the second threshold line L12.

The storage unit 14 stores the extraction threshold value set by the learning unit 16 and the decision threshold value set by the user (in Step ST18).

FIG. 3A illustrates an exemplary graph displayed on the display device 4. In FIG. 3A, the abscissa indicates the first feature quantity (area value), and the ordinate indicates the second feature quantity (length). In FIG. 3A, potential defects of non-defective product samples are indicated by the plus sign (+) and potential defects of defective product samples are indicated by the cross sign (×). That is to say, in the setting system 10 according to the first embodiment, the display device 4 displays (presents) the potential defects of the non-defective product samples and the potential defects of the defective product samples distinguishably from each other. In addition, in FIG. 3A, potential defects with the largest feature quantity, among the potential defects of the defective product samples, are designated by the indicators I1. In FIG. 3A, the user sets the first threshold line and the second threshold line L12 such that the indicators I1 fall outside of the first decision range R1.

When finding every potential defect of a given target 100 falling within the first decision range R1, for example, the go/no-go decision unit 13 determines the target 100 to be a “go.” On the other hand, when finding at least one potential defect of the given target 100 falling outside the first decision range R1, the go/no-go decision unit 13 determines the target 100 to be a “no-go.”

In the setting system 10 according to the first embodiment, not only the potential defects of the non-defective product samples and the potential defects of the defective product samples but also the indicators I1 are displayed as well as shown in FIG. 3A. This allows the user to set the decision threshold value for use in making a go/no-go decision on the target 100 simply by setting the first threshold line L11 and the second threshold line L12 such that the indicators I1 fall outside of the first decision range R1. In addition, the number of samples used to set the decision threshold value may be small as shown in FIG. 3A, thus enabling setting a decision threshold value suitably applicable to appearance inspection for high-mix low-volume production. Then, the user only needs to make naked eye inspection on only the target 100 that has been determined to be a “no-go” among the plurality of targets 100, thus lightening the inspection burden on the user. Note that every target 100 that has been determined to be a “go” must be a “go” among all sample given at the point in time when the decision threshold value is set, while the targets 100 that have been determined to be “no-go” may include non-defective products. Thus, to detect defective products with more reliability, the margin between the decision threshold value and the indicator I1 may be increased.

FIG. 3B illustrates another exemplary graph to be displayed on the display device 4. Although the graph shown in FIG, 3A is plotted based on the two feature quantities (namely, the first feature quantity and the second feature quantity), a graph may also be drawn based on a single feature quantity as shown in FIG. 3B. In FIG. 3B, the abscissa indicates the feature quantity (such as an area value), and the ordinate indicates the frequency of occurrence of the feature quantity. In addition, in FIG, 3B, the potential defects of non-defective product samples are indicated by dot pattern and the potential defects of defective product samples are indicated by hatching pattern. Furthermore, in FIG. 3B, the potential defects with the largest feature quantity among a plurality of potential defects of the defective product samples are designated by the indicators I1. Even in this case, the user is allowed to set the decision threshold value for use to make a go/no-go decision on the target 100 simply by setting a third threshold line L31 such that the indicators I1 fall within only one of the two ranges.

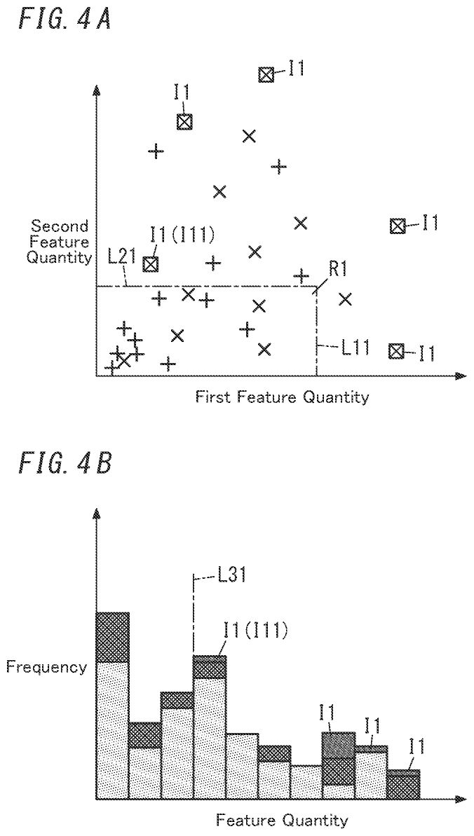

Meanwhile, even if the first threshold line L11 and the second threshold line L12 are set such that the indicators I1 fall outside of the first decision range R1, the potential defects of a plurality of (e.g., four in FIG. 4A) non-defective product samples may still fall outside of the first decision range R1 as shown in FIG. 4A. In that case, the shooting condition and/or the type of the feature quantity may have been set inappropriately. In FIG. 4A, among a plurality of (e.g., five in FIG. 4A) indicators I1, the second feature quantify of an indicator I11 has so small a value that the indicator I11 may have been specified improperly. In that case, with respect to a defective product sample including the indicator I11, extraction of the potential defects, calculation of the feature quantity of each potential defect, specification of the indicator I1, and other processing steps need to be performed all over again. Thus, even after a decision threshold value has been set once, a determination may also be made, based on the number of the potential defects of the non-defective product samples falling outside of the first decision range R1, whether or not the decision threshold value has been set properly.

Likewise, in FIG. 4B, among a plurality of (e.g., four in FIG. 4B) indicators I1, the feature quantity of an indicator I11 has so small a value that the indicator I11 may have been specified improperly. In that case, with respect to a defective product sample including the indicator I11, extraction of the potential defects, calculation of the feature quantity of each potential defect, specification of the indicator I1, and other processing steps need to be performed all over again.

In other words, if the shooting condition such as the camera position and the lighting condition is inappropriate, then some indicator may have a significantly small feature quantity. Even in such a situation, a determination may be made very easily, by plotting the indicators distinguishably as a graph, that the condition should be inappropriate.

### (3.2) Go/No-Go Decision on Target

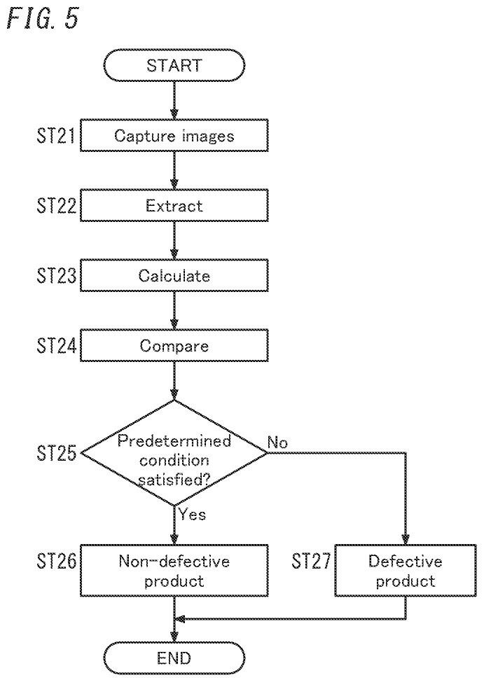

Next, it will be described with reference to FIG. 5 how the setting system 10 operates when making a go/no-go decision on the target 100. This processing is performed on the premise that the setting already described with reference to FIG. 2 has been done.

The image capture device 3 captures an image of an image capturing area, covering the target 100, in accordance with an image capture command signal supplied from the manufacturing system 20 at the timing when the target 100 is transported from the manufacturing system 20 to the setting system 10 (appearance inspection machine 300) (in Step ST21).

The extraction unit 11 compares the image of the target 100 captured by the image capture device 3 with the reference model, thereby acquiring their difference. Then, the extraction unit 11 compares the difference thus acquired with the extraction threshold value, thereby extracting a potential defect (in Step ST22).

The calculation unit 12 calculates a first feature quantity and a second feature quantity with respect to the potential defect extracted by the extraction unit 11 (in Step ST23).

The go/no-go decision unit 13 compares the potential detect of the target 100 with a decision threshold value (in Step ST24). When finding every potential defect of the target 100 falling within the first decision range R1 (i.e., if the answer is YES in Step ST25), the go/no-go decision unit 13 determines the target 100 to be a “go” (in Step ST26). On the other hand, when finding at least one potential defect of the target 100 falling outside of the first decision range R1 (i.e., if the answer is NO in Step ST25), the go/no-go decision unit 13 determines the target 100 to be a “no-go” (in Step ST27).

The user makes a naked eye inspection on the target 100 that has been determined to he a “no-go” as a result of the decision processing. That is to say, the user needs to make the naked eye inspection only on the target 100 that has been determined to be a “no-go” as a result of the decision processing, thus lightening the inspection burden on the user.

### (4) Exemplary Displays

Next, exemplary displays made by the display device 4 will be described with reference to FIGS. 6A-7D.

### (4.1) First Exemplary Display

First, a first exemplary display made by the display device 4 will be described with reference to FIGS. 6A-6D.

The display device 4 is configured to present at least a first display region 41, a second display region 42, a third display region 43, and a fourth display region 44 as shown in FIGS. 6A-6D.

The first display region 41 is a region in which a selection window that allows the user to select either a non-defective product sample or a defective product sample is displayed as shown in FIG. 6A. In the first display region 41, the total number of non-defective product samples and the total number of defective product samples which have been used to set the decision threshold value are displayed. In addition, in the first display region 41, a selection field that allows the user to select the sample number of a non-defective product sample and a selection field that allows the user to select the sample number of a defective product sample are also displayed. Thus, these selection fields allow the user to select the sample number of a non-defective product sample or the sample number of a defective product sample. Furthermore, in the first display region 41, the result of the go/no-go decision made for the selected sample is further displayed.

The second display region 42 is a region in which either a non-defective product image (object under test image) covering a non-defective product sample (target 100) or a defective product image (object under test image) covering a defective product sample (target 100) is displayed as shown in FIG. 6B. In the second display region 42, an object under test image of either the non-detective product sample or defective product sample selected in the first display region 41 is displayed. In FIG. 6A, a defective product sample with the sample number “2” is selected. Thus, in the second display region 42, a defective product image, which is an image of the defective product sample with the sample number “2,” is displayed. In FIG. 6B, the target 100 (defective product sample) has a plurality of (e.g., five in the example illustrated in FIG. 6B) potential defects 101-105.

The third display region 43 is a region in which the results of decision made for the non-detective product samples and the defective product samples are displayed as shown in FIG. 6C. In FIG. 6C, the results of decision indicate that 18 out of 20 non-defective product samples have turned out to be “go” and 2 out of the 20 non-defective product samples have turned out to be “no-go.” In addition, in FIG. 6C, the results of decision indicate that none of 7 defective product samples have turned out to be “go” and all of the 7 defective product samples have turned out to be “no-go.” The user has only to inspect, with the naked eye, the targets 100 that have turned out to be “no-go,” thus lightening the inspection burden on the user.

The fourth display region 44 is a region in which a graph showing the relation between the first feature quantity and the second feature quantity with respect to each potential defect and the threshold value of the go/no-go decision are displayed as shown in FIG. 6D. In FIG. 6D, the potential defects of all non-defective product samples and all defective product samples are displayed. In FIG. 6D, the potential defects 101-105 of the defective product sample selected on the selection window shown in FIG. 6A are displayed differently from the other non-defective product samples and defective product samples. Specifically, in FIG. 6D, as for the potential defects 101-105 of the defective product sample selected, the cross sign “X” is surrounded with a

circular dot pattern. This makes the potential defects 101-105 easily distinguishable from the other potential defects. Note that as for the potential defects 101, 105 with the largest feature quantity, the cross sign “X” is enclosed in an open square “□” indicating that this is an indicator I1.

### (4.2) Second Exemplary Display

Next, a second exemplary display made by the display device 4 will be described with reference to FIGS. 7A-7D.

The display device 4 is configured to present at least the first display region 41, the second display region 42, the third display region 43, and a fourth display region 44A as shown in FIGS. 7A-7D. The first display region 41, the second display region 42, and the third display region 43 are the same as their counterparts of the first exemplary display and detailed description thereof will be omitted herein.

In the setting system 10 according to the first embodiment, the borderline defect selecting unit 22 of the input device 2 allows the user to select a borderline defect 110 as described above. In FIG. 7B, among the potential defects 101-105, the potential defect 103 is selected as the borderline defect 110. In that case, the user enters the first threshold line L11 and the second threshold line L21 such that the borderline defect 110 falls outside of the first decision range R1. This enables improving the go/no-go decision accuracy. Note that the borderline defect 110 may be selected by, for example, having the user make a right click with a mouse and select a borderline defect on a pull-down menu displayed on the screen.

In the fourth display region 44A, as well as in the fourth display region 44, the potential defects of all non-defective product samples and all defective product samples are displayed. In FIG. 7D, the potential defects 101-105 of the defective product sample selected on the selection window shown in FIG. 7A are displayed differently from the potential defects of the other non-detective product samples and defective product samples. Unlike in FIG. 6D, as for the potential defect 103, as well as the potential defects 101, 105, the cross sign “X” is enclosed in an open square “□” indicating that this is an indicator I1. In addition, in FIG. 7D, the potential defect 103 selected as the borderline defect 110 is displayed differently from the other potential defects 101, 102, 104, 105. Specifically, in FIG. 7D. as for the potential defects 101, 102, 104, 105, the cross sign “X” is surrounded with a circular dot pattern as in FIG. 6D. As for the potential defect 103 (borderline defect 110), on the other hand, the cross sign “X” is surrounded with a square dot pattern. This makes the potential defect 103 as the borderline defect 110 easily distinguishable from the potential defects 101, 102, 104, 105.

In FIG. 7D, the indicators I1 and the borderline defect 110 are both displayed. However, this is only an example and should not be construed as limiting. Rather, only the borderline defect 110 needs to be displayed and the indicators I1 do not have to be displayed.

### (5) Advantages

In the setting system 10 according to the first embodiment, the display device 4 displays not only potential defects of a non-defective product sample and a defective product sample but also a potential defect with the largest feature quantity value, out of the potential defects of the defective product sample, as an indicator I1. This allows the user to set the decision threshold value easily by drawing the first threshold line L11 and the second threshold line L12 such that the indicator I1 falls outside of the first decision range R1. In addition, this also allows the user to easily set a. decision threshold value that would cause over-detection. That is to say, every target that has been determined to be a “go” must be a “go,” and therefore, there is no need to make any naked-eye inspection on the target. This may reduce the man hours required for the naked-eye inspection. In addition, the setting system 10 according to the first embodiment enables setting the decision threshold value based on a small number of (e.g., several or at most a few ten) samples as described above. This enables changing the way to use this setting system 10 stepwise such that the decision threshold value is initially set to allow for a certain degree of over-detection and then gradually changed to increase the detection rate as the number of samples increases. Thus, the setting system 10 according to the first embodiment enables setting a decision threshold value suitably applicable to appearance inspection for high-mix low-volume production. As used herein, the “over-detection” refers to a state where every target that has been determined to be a “go” must be a “go.” while the targets that have been determined to be “no-go” may include some non-defective products. In other words, it can be said that every defective product is determined to be a “no-go.”

In addition, the setting system 10 according to the first embodiment makes the display device 4 display, as shown in FIG. 3A, the potential defects of non-defective product samples (as indicated by the plus “+” signs in FIG. 3A) and the potential defects of defective product samples (as indicated by the cross “X” sign in FIG. 3A) distinguishably from each other. This achieves the advantage of allowing the user who is looking at the display device 4 to easily distinguish the potential defects of the non-defective product samples and the potential defects of the defective product samples from each other at a glance.

Furthermore, the setting system 10 according to the first embodiment makes the display device 4 display, as a graph, the potential defects of non-defective product samples and the potential defects of defective product samples. This makes it easier for the user to set the decision threshold value because the user is allowed to set the decision threshold value while looking at the graph.

### (6) Variations

Note that the first embodiment described above is only an exemplary one of various embodiments of the present disclosure and should not be construed as limiting. Rather, the first embodiment may be readily modified in various manners depending on a design choice or any other factor without departing from the scope of the present disclosure. Also, the functions of the setting system 10 according to the first embodiment may also be implemented as, for example, a setting method, a computer program, or a non-transitory storage medium that stores a computer program thereon.

A setting method according to an aspect is applicable to an appearance inspection machine 300 to inspect appearance of a plurality of targets 100. The setting method includes an extraction step (Step ST14), a calculation step (Step ST15), and a presentation step (Step ST16) as shown in FIG. 2. The extraction step includes acquiring a first difference between a non-defective product image, covering a non-defective product sample to be classified as a non-defective product among the plurality of targets 100, and a reference model. The extraction step also includes acquiring a second difference between a defective product image, covering a defective product sample to be classified as a defective product among the plurality of targets 100, and the reference model. The extraction step further includes extracting, as a potential defect, either the first difference or the second difference, whichever satisfies a particular condition. The calculation step includes calculating at least one feature quantity with respect to the potential defect extracted in the extraction step. The calculation step includes specifying, when the defective product sample includes a plurality of defective product samples and respective feature quantities of the potential defects extracted from the plurality of defective product samples have multiple different values, at least one of the feature quantities that has an N^{th} largest one (where N is a natural number) of the multiple different values as an indicator I1. The presentation step includes presenting the indicator I1 specified in the calculation step. A program according to another aspect is designed to cause one or more processors to perform the setting method described above.

Next, variations of the first embodiment will be enumerated one after another. Note that the variations to he described below may be adopted in combination as appropriate.

### (6.1) First Variation

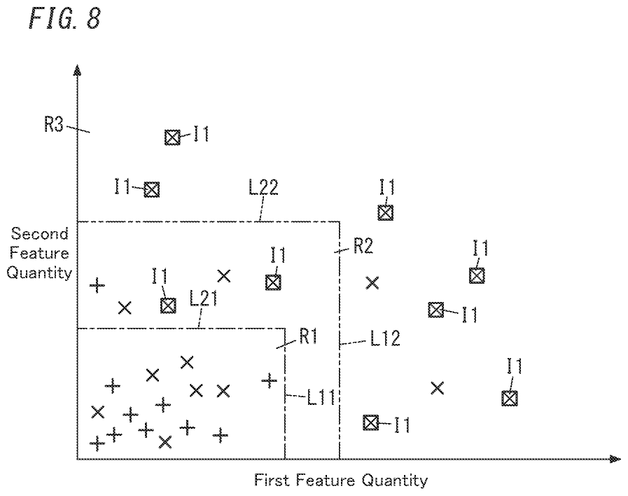

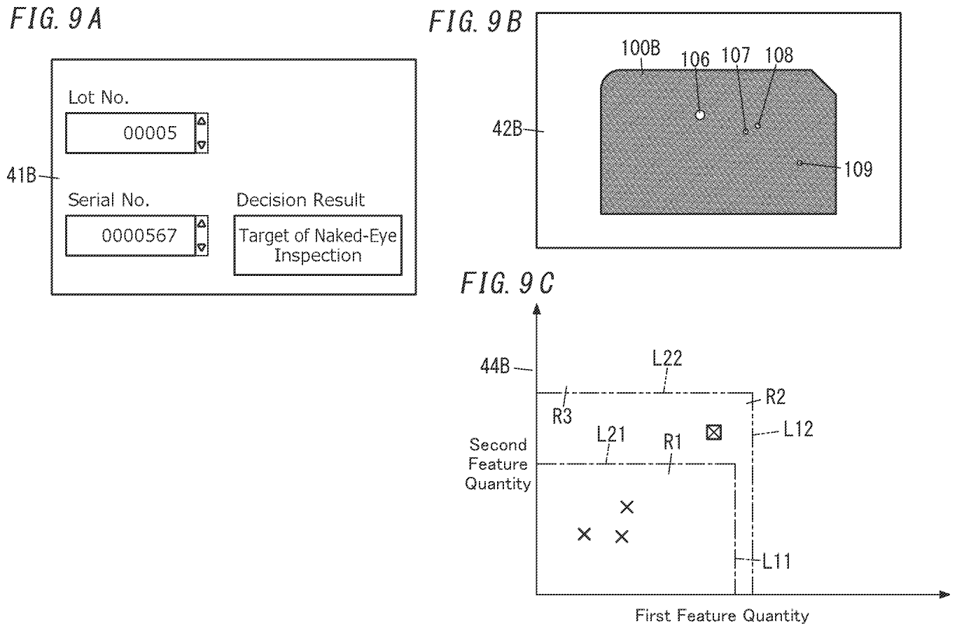

In the first embodiment described above, only one decision threshold value is used. Alternatively, two decision threshold values may also be used. A setting system 10 according to a first variation will be described with reference to FIG. 8 and FIGS. 9A-9C. Note that the setting system 10 according to the first variation has the same configuration as the setting system 10 according to the first embodiment. Thus, any constituent element of this first variation, having the same function as a counterpart of the first embodiment, will be designated by the same reference numeral as that counterpart's, and description thereof will be omitted herein.

FIG. 8 shows an exemplary graph to be displayed on the display device 4. In FIG. 8, a first pair of the first threshold line L11 and the second threshold line L21 are drawn, and a first decision threshold value is set as one decision threshold value to make the indicators I1 of defective product samples fall outside of the range. In addition, in FIG, 8, a second pair of the first threshold line L12 and the second threshold line L22 are drawn, and a second decision threshold value is set as another decision threshold value to make all potential defects of non-defective product samples fall within the range. According to the first variation, the graph is classified into a first decision range R1, a second decision range R2, and a third decision range R3 by these first threshold lines L11, L12 and second threshold lines L21, L22.

The go/no-go decision unit 13 determines, when finding every potential defect of a given target 100B falling within the first decision range R1, for example, the target 100B to be a “go.” On the other hand, the go/no-go decision unit 13 determines, when finding at least one potential defect of the target 100B falling within the third decision range R3, for example, the target 100B to be a “no-go.” Furthermore, the go/no-go decision unit 13 determines, when finding at least one potential defect of the target 100B falling within the second decision range R2 and not a single potential defect falling within the third decision range R3, the target 100B to be a product to be reinspected. As used herein, the “product to be reinspected” refers to a target 100B determined to be neither a “go” nor a “no-go” and requiring reinspection. Specifically, the “product to be reinspected” refers to a target 100B that requires the user to make a naked-eye inspection.

FIGS. 9A-9C illustrate an exemplary display to be made by the display device 4 of the selling system 10 according to the first variation. The display device 4 is configured to present at least a first display region 41B, a second display region 42B, and a fourth display region 44B.

The first display region 41B is a region in which a selection window that allows the user to select an inspected target 100B is displayed as shown in FIG. 9A. In the first display region 41B, the lot number, serial number, and result of decision of the target 100B are displayed. In FIG. 9A, a target 100B (inspected product), of which the lot number is “00005” and the serial number is “0000567,” has been selected and determined to be a product to be reinspected (target of naked-eye inspection). That is to say, this target 100B requires the user to make a naked-eye inspection.

The second display region 42B is a region in which an image of the target 100B selected on the selection window shown in FIG, 9A is displayed as shown in FIG. 9B. In FIG. 9A, a target 100B, of which the lot number is “00005” and the serial number is “0000567,” has been selected. Thus, in the second display region 42B, an image of the target 100B, of which the lot number is “00005” and the serial number is “0000567,” is displayed. In FIG. 9B, the target 100B has a plurality of (e.g., four in the example illustrated in FIG. 9B) potential defects 106-109.

The fourth display region 44B is a region in which a graph showing the relation between the first feature quantity and the second feature quantity of each potential defect is displayed as shown in FIG. 9C. In FIG. 9C, the potential defects of the target 100B selected on the selection window shown in FIG. 9A are displayed. In FIG. 9C, the graph is classified by the first threshold lines L11, L12 and the second threshold lines L21, L22 into a first decision range R1, a second decision range R2, and a third decision range R3. In FIG. 9C. the feature quantities of the potential defects 107-109 fall within the first decision range R1 but the feature quantity of the potential defect 106 falls within the second decision range R2. Thus, the go/no-go decision unit 13 determines the target 100B to be a product to be reinspected (i.e., a target that requires naked-eye inspection) as shown in FIG. 9A.

In the setting system 10 according to the first variation, the go/no-go decision unit 13 determines, when finding every potential defect falling within the first decision range R1 inside the first decision threshold value, the target 100B to be a “go.” On the other hand, the go/no-go decision unit 13 determines, when finding at least one potential defect falling within the third decision range R3 outside of the second decision threshold value, the target 100B to be a “no-go.” Furthermore, the go/no-go decision unit 13 determines, when finding at least one potential defect falling within the second decision range R2 between the first decision threshold value and the second decision threshold value and no potential defects falling within the third decision range R3, the target 100B to be a product to be reinspected. This requires the user to make a naked-eye inspection only on the target 100B determined to be a product to he reinspected, thus further lightening the inspection burden on the user.

### (6.2) Second Variation

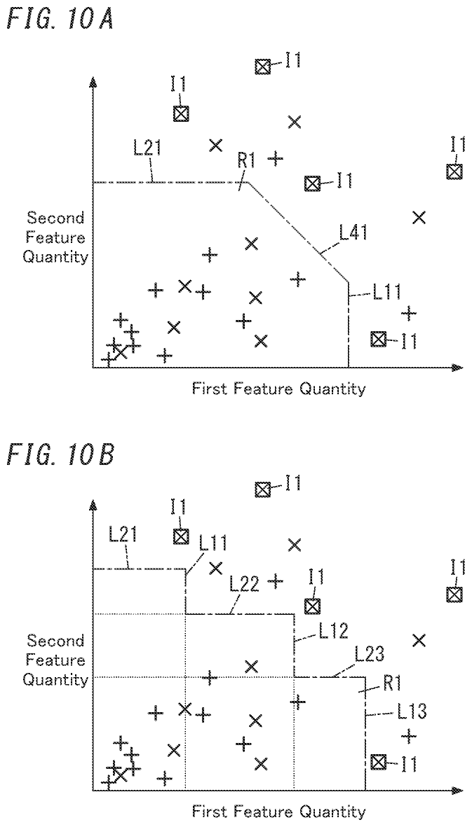

In the first embodiment described above, the first decision range R1 is a quadrangular one. However, this is only an example and should not be construed as limiting. Alternatively, the first decision range R1 may also be a trapezoidal one as shown in FIG. 10A or a combination of a plurality of polygons as shown in FIG. 10B.

In FIG. 10A, the first decision range R1 is defined as a trapezoidal one by not only the first threshold line L11 and the second threshold line L21 but also a fourth threshold line L41. In FIG. 10B, the first decision range R1 is defined as a combination of a plurality of polygons by a plurality of (e.g., three in the example illustrated in FIG. 10B) first threshold lines L11-L13 and a plurality of (e.g., three in the example illustrated in FIG. 10B) second threshold lines L21-123.

Still alternatively, the first decision range R1 may also be defined to have a fan shape by a single threshold line

### (6.3) Other Variations

Next, other variations of the first embodiment will be enumerated one after another.

In the setting system 10 according to the present disclosure, the control device 1 includes a computer system. The computer system may include, as principal hardware components, a processor and a memory. The functions of the setting system 10 according to the present disclosure may be performed by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits include a system LSI, a very large-scale integrated circuit (VLSI), and an ultra-large-scale integrated circuit (ULSI). Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be integrated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a largescale integrated circuit.

Also, in the embodiment described above, the plurality of constituent elements (or the functions) of the setting system 10 are integrated together in a single housing. However, this is only an example and should not be construed as limiting. Alternatively, those constituent elements (or functions) of the setting system 10 may also be distributed in multiple different housings. Still alternatively, at least some functions of the setting system 10 (e.g., some functions of the control device 1) may be implemented as a cloud computing system as well.

Conversely, in the first embodiment described above, at least some functions of the setting system 10 that are distributed in a plurality of devices may be aggregated together in a single housing. For example, some functions of the setting system 10, which are distributed in the control device 1 and the display device 4, may be aggregated together in a single housing.

In the first embodiment, the calculation unit 12 calculates one or two feature quantities with respect to each of the potential defects. Alternatively, the calculation unit 12 may calculate three or more feature quantities. That is to say, the calculation unit 12 just needs to be configured to calculate at least one feature quantity with respect to each of the potential defects and may also be configured to calculate two or more feature quantities.

In the first embodiment described above, the calculation unit 12 specifies at least one feature quantity of a potential defect with the largest value, out of the respective feature quantities of the plurality of potential defects, as the indicator I1. However, the indicator I1 may be a feature quantity with an N^{th} largest one of the multiple different values and does not have to be a feature quantity with the largest value. Thus, the calculation unit 12 may specify, for example, a feature quantity with the third largest value as the indicator I1 or may also specify a feature quantity with the smallest value as the indicator I1.

In the first embodiment described above, the first feature quantity is the area value of a potential defect, and the second feature quantity is the major diameter (length) of the potential defect. However, this is only an example and should not be construed as limiting. Alternatively, the first feature quantity may also be the area value of a potential defect and the second feature quantity may also be the luminance (average luminance) of the potential defect. Still alternatively, the first feature quantity may also be the luminance (average luminance) of a potential defect and the second feature quantity may also be the major diameter (length) of the potential defect.

In the first embodiment described above, the display device 4 serving as the presentation unit presents, as a graph, the feature quantities of the potential defects. However, this is only an example and should not be construed as limiting. Rather, the display device 4 has only to be configured to present the indicators I1. Thus, the display device 4 may present a table including the indicators I1, for example. In that case, the user may set the decision threshold value based on the indicators I1 included in the table.

In the first embodiment described above, the graph is a two-dimensional one. Alternatively, the graph may also be a one-dimensional one or a three-dimensional one, for example. Furthermore, in the first embodiment described above, the graph is either a scatter plot or a bar graph. Alternatively, the graph may also be a polygon graph or a pie chart, for example.

In the first embodiment described above, the presentation unit is implemented as the display device 4. However, this is only an example and should not be construed as limiting. The presentation unit has only to be configured to present the indicators I1 and may be, for example, a voice output unit for presenting the indicators I1 in a voice. Even in that case, the user may also set the decision threshold value based on the indicators I1 presented in a voice.

In the first embodiment described above, the control device 1 is implemented as a personal computer. However, this is only an example and should not he construed as limiting. Alternatively, the control device 1 may also be implemented as a tablet computer, a personal digital assistant (PDA), or a smartphone.

In the first embodiment described above, the extraction threshold value is set based on the average and variance values of the luminance of a reference model (non-defective product model). Alternatively, the extraction threshold value may also be set based on the absolute error from the average of the luminance. Optionally, the reference model may also be a single image.

In the first embodiment described above, the first threshold lines L11, L12 and the second threshold lines L21, L22 to specify the decision threshold value are linear. However, this is only an example and should not he construed as limiting. Alternatively, the first threshold lines L11, L12 and the second threshold lines L21, L22 may also be curved, for example.

In the first embodiment described above, the appearance inspection machine 300 includes the setting system 10. However, the appearance inspection machine 300 does not have to include the setting system 10. That is to say, the appearance inspection machine 300 and the setting system 10 may also be provided separately from each other.

Also, the calculation unit 12 specifies a feature quantity with an N^{th} largest value (where N is a natural number), out of the feature quantities of the respective potential defects extracted from the plurality of defective product samples, as the indicator I1. However, N does not have to be a single number. Alternatively, the indicators I1 may also be specified by defining N to be a plurality of numbers (e.g., may be a feature quantity with the largest value and a feature quantity with the second lamest value).

In the first embodiment, a so-called “online type” setting system 10 and an appearance inspection machine 300 have been described. However, this is only an example and should not he construed as limning. That is to say, the setting system 10 and the appearance inspection machine 300 may also be of a so-called “offline” type. In that case, the setting system 10 and the appearance inspection machine 300 do not have to be connected to the transporter 201 of the manufacturing system 20.

### Second Embodiment

Next, a setting system and appearance inspection machine according to a second embodiment will be described.

### (1) Overview

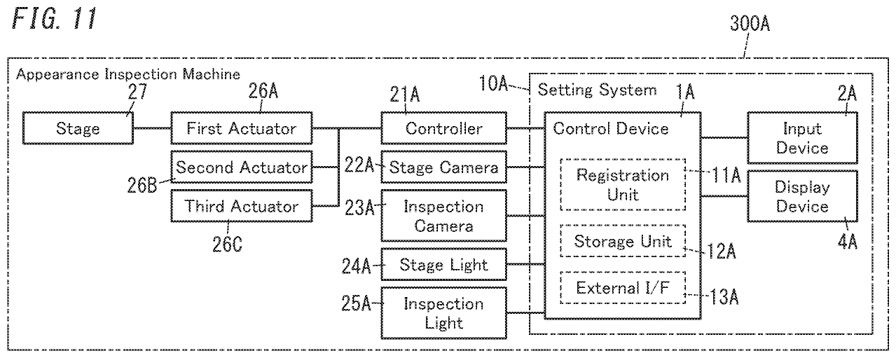

First, an overview of a setting system 10A and appearance inspection machine 300A according to the second embodiment will be described with reference to FIG. 11,

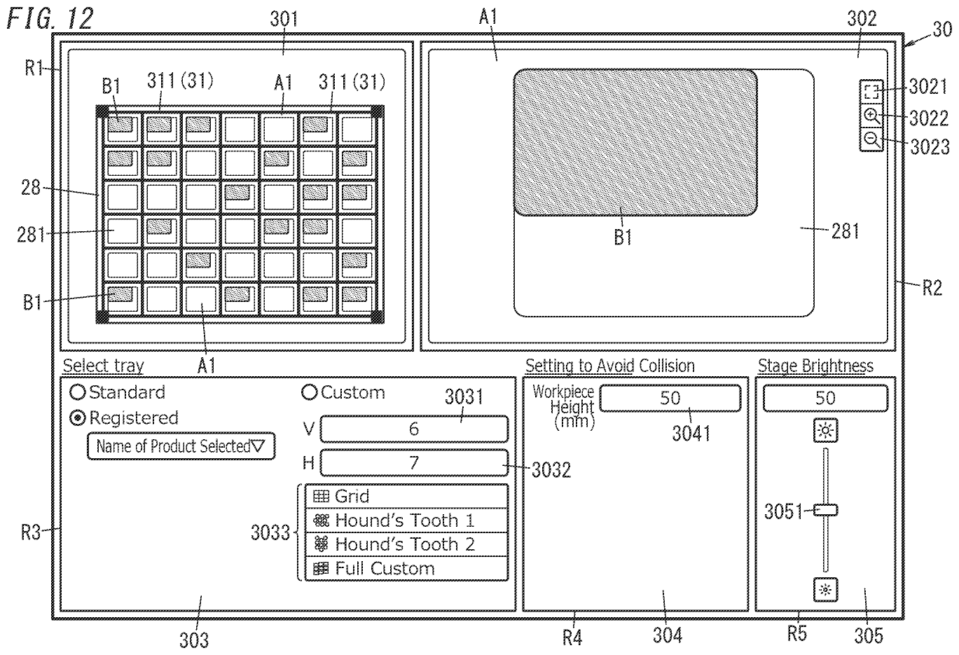

The setting system 10A according to the second embodiment may be used in, for example, an appearance inspection machine 300A. In other words, the appearance inspection machine 300A includes the setting system 10A. The appearance inspection machine 300A performs appearance inspection on an object under test B1 (see FIG. 12) falling within an inspection area A1 (see FIG. 12) based on an inspection image 302 (see FIG. 12) covering the inspection area A1. The object under test B1 may be, for example, a chip component such as a resistor, a capacitor, or an inductor. Note that the object under test B1 does not have to be a chip component but may also be a circuit board, a sheet metal part such as a leaf spring, or a resin molded product such as a cover. The appearance inspection machine 300A inspects the appearance of, for example, a chip component as the object under test B1 for any defect such as dirt, scratch, bur, or chipping on its outer surface. The appearance inspection machine 300A may either be incorporated into the production line of the chip component or perform the appearance inspection outside of the production line.

The setting system 10A is configured to set an inspection area A1 on a settings window 30 (see FIG. 12) displayed on the display device 4A (to be described later). As used herein, the “inspection area” refers to an area which is set to cover the object under test and may be set to cover, in its entirety, a single object under test associated with the inspection area. Thus, the inspection area A1 may cover, as long as a single object under test B1 associated with the inspection area A1 is covered, other objects under test B1 only partially. Conversely, when the appearance inspection needs to be performed on only a part of the object under test B1, the inspection area A1 may also be set to cover, in its entirety, the single object under test including that part of the single object under test B1.

Meanwhile, in a dedicated appearance inspection machine such as the one disclosed in Patent Literature 3, the location of the object under test is determined in advance, and therefore, there is no need to locate the object under test. In addition, even in an appearance inspection machine for low-mix high-volume production, which is not a dedicated appearance inspection machine, the inspection area also needs to be set. In that case, however, the number of types of the objects under test is too small to cause a problem in the man hours required.

In contrast, in a general-purpose inspection apparatus and an inspection apparatus designed for high-mix low-volume production, the number of types of objects under test is so large that the inspection area needs to be set all over again, every time the objects under test are changed, thus often causing a problem in the man hours required. Also, if the tray to house the objects under test has a hound's tooth shape, for example, the inspection apparatus of Patent Literature 4, which relies on inputting numerical values, requires too many man hours to sufficiently deal with the high-mix low-volume production. In the following description, a general-purpose setting system 10A and appearance inspection machine 300A, allowing the inspection area A1 to be set easily and suitably applicable to general-purpose appearance inspection (more preferably, appearance inspection for high-mix low-volume production (hereinafter simply referred to as “general-purpose appearance inspection”)) will be described.

In the selling system 10A according to the second embodiment, the settings window 30 (see FIG. 12) displayed on the display device 4A serving as a display unit includes an overall image 301 including a plurality of inspection areas A1 and indicators 311 to be superimposed on the overall image 301. The setting system 10A includes a registration unit 11A. The registration unit 11A registers the plurality of inspection areas A1 according to the locations of the indicators 311 on the settings window 30.

The setting system 10A according to the second embodiment superimposes the indicators 311 on the overall image 301 and sets each inspection area A1 according to the location of an associated one of the indicators 311. This allows the inspection area A1 to be set just by determining the location of the indicator 311 such that the inspection area A1 covers the object under test B1. That is to say, the setting system 10A according to the second embodiment allows the user to set the inspection area A1 both in and easily, thus enabling setting the inspection area A1 suitably applicable to general-purpose appearance inspection.

### (2) Configuration

Next, the configuration of the setting system 10A and appearance inspection machine 300A according to the second embodiment will be described with reference to FIG. 1.

### (2.1) Configuration of Appearance Inspection Machine

An appearance inspection machine 300A according to the second embodiment includes the setting system 10A, a stage 27, a controller 21A, a stage camera 22A, an inspection camera 23A, a stage light 24A, and an inspection light 25A as shown in FIG. 11. In addition, the appearance inspection machine 300A further includes a first actuator 26A, a second actuator 26B, and a third actuator 26C. Note that the setting system 10A will be described in detail later in the “(2.2) Configuration of setting system” section.

The stage 27 is a supporting stage, which may be formed, for example, in the shape of a rectangular plate in plan view. The stage 27 may be moved in a first direction (e.g., rightward/leftward direction) by the first actuator 26A. On one surface (upper surface) of the stage 27, a tray 28 (see FIG. 12) holding a plurality of objects under test B1 thereon is put.

The controller 21A controls, in accordance with a control command given by the control device 1A of the setting system 10A, the first actuator 26A, the second actuator 26B, and the third actuator 26C. The controller 21A includes a drive circuit. The drive circuit controls the ON/OFF states of a first motor included in the first actuator 26A, the ON/OFF states of a second motor included in the second actuator 26B, and the ON/OFF states of a third motor included in the third actuator 26C.

The stage camera 22A may be an area camera, for example. The area camera is a two-dimensional camera including an image sensor in which a plurality of photosensitive elements (such as photodiodes) are arranged two-dimensionally. The image sensor may be, for example, a two-dimensional image sensor such as a charge-coupled device (CCD) image sensor or a complementary metal-oxide semiconductor (CMOS) image sensor. The stage camera 22A has its shooting range set to capture, in its entirety, the tray 28 put on the stage 27. That is to say, the stage camera 22A is a first shooting unit for shooting the overall image 301 (see FIG. 12) including the plurality of inspection areas A1.

The inspection camera 23A, as well as the stage camera 22A, is an area camera. The inspection camera 23A has its shooting range set to capture respective inspection areas A1. That is to say, the inspection camera 23A is a second shooting unit for shooting an inspection image 302 (see FIG. 12) covering the respective inspection areas A1. The relationship between the inspection areas A1 and the field of view of the inspection camera 23A will be described later.

The stage light 24A is configured to irradiate the tray 28, falling within the shooting range of the stage camera 22A, with light. A light source for the stage light 24A may be a light-emitting diode, for example.

The inspection light 25A is configured to irradiate the respective inspection areas A1, falling within the shooting range of the inspection camera 23A, with light. The inspection light 25A may be, for example, a ring light with an annular light source. Using a ring light as the inspection light 25A reduces the chances of casting shadows to the object under test B1 and allows the object under test B1 to be irradiated with light uniformly. The ring light may be configured to include, for example, a circuit board on which a plurality of light-emitting diodes are arranged along a circumference thereof.

The first actuator 26A includes a first motor. The first motor has its operation controlled by the drive circuit of the controller 21A. The first actuator 26A may be moved in a first direction (such as a rightward/leftward direction) by running the first motor, The stage 27 is mounted onto the first actuator 26A. Thus, causing the first actuator 26A to move in the first direction allows the stage 27 to move in the first direction as well.

The second actuator 26B includes a second motor. The second motor has its operation controlled by the drive circuit of the controller 21A. The second actuator 26B may be moved in a second direction (such as an upward/downward direction) by running the second motor. The stage camera 22A, the inspection camera 23A, the stage light 24A, and the inspection light 25A are coupled to the second actuator 26B. Thus, causing the second actuator 26B to move in the second direction allows the stage camera 22A, the inspection camera 23A, the stage light 24A, and the inspection light 25A to move in the second direction as well.

In the embodiment described above, the inspection camera 23A and the inspection light 25A are configured to be moved at a time by the single second actuator 26B. Alternatively, the inspection camera 23A and the inspection light 25A may also be configured to be moved separately from each other by two different actuators, respectively. In that case, the stage camera 22A and the stage light 24A may be configured to move along with the inspection camera 23A or may also be configured to move along with the inspection light 25A.

The third actuator 26C includes a third motor. The third motor has its operation controlled by the drive circuit of the controller 21A. The third actuator 26C may cause the second actuator 26B to move in a third direction (such as a forward/backward direction) by running the third motor. Thus, causing the second actuator 26B to move in the third direction allows the stage camera 22A, the inspection camera 23A, the stage light 24A, and the inspection light 25A coupled to the second actuator 26B to move in the third direction as well.

### (2.2) Configuration of Setting System

The setting system 10A includes the control device 1A, an input device 2A, and a display device 4A serving as a display unit as shown in FIG. 11. In the second embodiment, the display device 4A is one of the constituent elements of the setting system 10A. However, the display device 4A does not have to be one of the constituent elements of the setting system 10A.

The control device 1A may be, for example, a personal computer. As shown in FIG. 11, the control device 1A includes a registration unit 11A, a storage unit 12A, and an external interface 13A. Note that in FIG. 11, the external interface 13A is abbreviated as “external I/F 13A” and will be hereinafter referred to as such.

The control device 1A is implemented as a computer system including a processor and a memory. The computer system performs the function of the control device 1A by making the processor execute an appropriate program. The program may be stored in advance in the memory. Alternatively, the program may also be downloaded via a telecommunications line such as the

Internet or distributed after having been stored in a non-transitory storage medium such as a memory card.

The registration unit 11A is configured to register the plurality of inspection areas A1 according to the locations of the indicators 311 on the settings window 30 displayed on the display device 4A. Specifically, the registration unit 11A registers, as respective inspection areas A1, a plurality of areas surrounded with the respective indicators 311 which are set according to the respective holding spaces 281 of the trays 28 included in the overall image 301. Thus, the size of each inspection area A1 and the interval (pitch) between adjacent inspection areas A1 may be changed by changing the sizes of the respective indicators 311 and the interval (pitch) between adjacent indicators 311. Note that the location and size of each indicator 311 may be changed by the control device 1A (e.g., by the registration unit 11A) in accordance with a particular operation performed by the user using the input device 2A. As used herein, the “location” is a concept encompassing not only an absolute location but also a relative location representing the interval (pitch) between adjacent inspection areas A1.

The storage unit 12A may be, for example, a hard disk drive (HDD). The storage unit 12A stores the overall image 301 shot with the stage camera 22A and the inspection image 302 shot with the inspection camera 23A. In addition, the storage unit 12A also stores the plurality of inspection areas A1 registered by the registration unit 11A. Moreover, the storage unit 12A further stores inspection information in a situation where the object under test B1 is subjected to appearance inspection by the appearance inspection machine 300A. The inspection information may include, for example, an extraction threshold value for use to binarize a defective part included in the object under test B1 and a decision threshold value for use to determine whether the object under test B1 is a non-defective product or not.

The external I/F 13A is a connection interface that connects the control device 1A, the input device 2A, and the display device 4A to each other. That is to say, the control device 1A may be connected to each of the input device 2A and the display device 4A via the external I/F 13A. The external I/F 13A is also a connection interface that connects the control device 1A to the controller 21A, the stage camera 22A, the inspection camera 23A, the stage light 24A, and the inspection light 25A. That is to say, the control device 1A may also be connected to each of the controller 21A, the stage camera 22A, the inspection camera 23A, the stage light 24A, and the inspection light 25A via the external I/F 13A.

The input device 2A is an input interface for inputting information to the control device 1A. The input device 2A may be connected to the control device 1A via the external I/F 13A. The input device 2A may include, for example, a keyboard and a pointing device. This allows the user (worker) to enter information with respect to the control device 1A by operating the keyboard and the pointing device. The pointing device may be a mouse, for example, but may also be a touchscreen panel, a touch pad, a pen tablet, or a track ball, for example.

The display device 4A may be a liquid crystal display, for example. The display device 4A may be connected to the control device 1A via the external I/F 13A. The display device 4A is configured to display at least the settings window 30 (see FIG. 12). The display device 4A may also be a touchscreen panel display. The settings window 30 will be described in detail later in the “(3) Settings window” section.

In this case, in the appearance inspection machine 300A according to the second embodiment, the overall image 301 covering the tray 28 is shot with the stage camera 22A and the inspection image 302 covering the inspection area A1 is shot with the inspection camera 23A provided separately from the stage camera 22A. Thus, the shooting ranges of these two cameras could shift from each other due to an error in the installation positions of the stage camera 22A and the inspection camera 23A or deterioration with time, for example. To overcome such a problem, the setting system 10A according to the second embodiment has the capability of calibrating the stage camera 22A and the inspection camera 23A. In other words, the setting system 10A has the capability of calibrating the stage camera 22A (first shooting unit) for shooting the overall image 301 and the inspection camera 23A (second shooting unit) for shooting the inspection image 302.

For example, a calibration plate with two markers may be set on the stage 27 and shot with the stage camera 22A and the inspection camera 23A. In this manner, the magnitude of correction may be calculated. The correction may also be made by projective transformation by increasing the number of markers on the plate.

### (3) Settings Window

Next, the settings window 30 displayed on the display device 4A will be described with reference to FIG. 12.

As shown in FIG. 12, the settings window 30 includes a first display region R1, a second display region R2, a third display region R3, a fourth display region R4, and a fifth display region R5. The first display region R1 is a region to display the overall image 301 covering the tray 28. The second display region R2 is a region to display an inspection image 302 corresponding to the inspection area A1 selected on the overall image 301. The third display region R3 is a region to display a selection window 303 allowing the user to select the configuration (specification) of the tray 28. The fourth display region R4 is a region to display a height entry window 304 allowing entering the height of the surface (upper surface) of the object under test B1 as measured from the mounting surface (upper surface) of the stage 27, i.e., the height of the object under test (workpiece) B1. The fifth display region R5 is a region to display an illuminance settings window 305 allowing the user to set the brightness on the stage 27 (i.e., the illuminance of the stage light 24A).

In FIG. 12, the first display region R1 and the second display region R2 are arranged side by side in the rightward/leftward direction such that the first display region R1 is located on the left and the second display region R2 is located on the right in an upper part of the settings window 30. Also, in FIG. 12. the third display region R3, the fourth display region R4, and the fifth display region R5 are arranged side by side in this order in the rightward/leftward direction (i.e., from left to right) in a lower part of the settings window 30.

In the first display region R1, displayed is the overall image 301 shot with the stage camera 22A. The overall image 301 is an image covering the tray 28. The tray 28 includes a plurality of holding spaces 281, in each of which an object under test B1 is held. In addition, in the first display region R1 a group of indicators 31 is further displayed to be superimposed on the overall image 301. The group of indicators 31 includes a plurality of (e.g., forty-two in the example illustrated in FIG. 12) indicators 311. Each of the plurality of indicators 311 may be a rectangular frame, for example. Each of the plurality of indicators 311 is set to include an associated one of the holding spaces 281 of the tray 28. An area surrounded with each of the plurality of indicators 311 is defined to be the inspection area A1. That is to say, each indicator 311 includes a frame-shaped object that surrounds an associated one of the plurality of inspection areas A1. In addition, in the setting system 10A, the plurality of indicators 311 corresponding to the plurality of inspection areas A1 are displayed collectively as the group of indicators 31. As described above, the settings window 30 includes the overall image 301 covering the plurality of inspection areas A1 and the indicators 311 to be superimposed on the overall image 301.

In the first display region R1, the indicators 311 may be changed with respect to the overall image 301 in response to the operation performed by the user. In the second embodiment, the location and size of each indicator 311 are changeable. However, this is only an example and should not be construed as limiting. Alternatively, art least one of the location, size, or shape of the indicator 311 may be changeable. The procedure of changing the indicator 311 will be described in detail later in the “(4) Exemplary operation” section.

In the second display region R2, the inspection image 302 shot with the inspection camera 23A is displayed. The inspection image 302 is an image covering an inspection area A1 selected from the plurality of inspection areas A1 included in the overall image 301. That is to say, the settings window 30 further includes the inspection image 302 covering the inspection area A1 selected from the plurality of inspection areas A1 of the overall image 301.

In addition, in the second display region R2, a select button 3021, a zoom up button 3022, and a zoom down button 3023 are further superimposed on the inspection image 302. The select button 3021 is a button allowing the user to select a part of the inspection image 302. The zoom up button 3022 is a button allowing the user to zoom up the inspection image 302 at a certain zoom power. The zoom down button 3023 is a button allowing the user to zoom down the inspection image 302 at a certain zoom power.

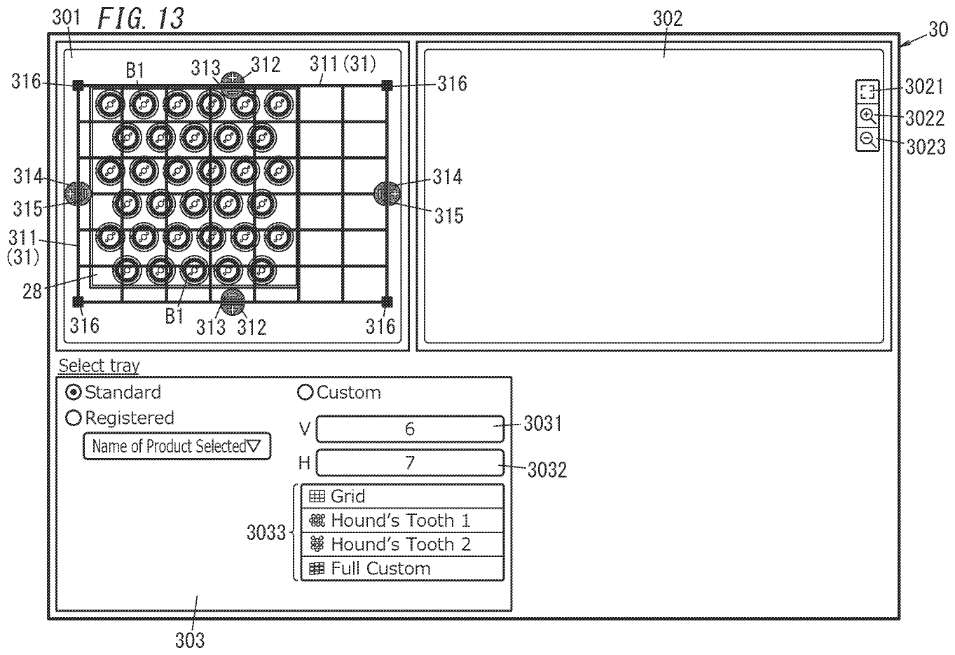

In the third display region R3, a selection window 303 allowing the user to select the configuration (specification) of the tray 28 is displayed. In the example illustrated in FIG. 12, one of a “standard tray,” a “registered tray,” or a “custom tray” may be selected. The “standard tray” is a preset standard tray. If the “standard tray” is selected on the selection window 303, then a group of indicators 31 forming a matrix of six rows by seven columns, for example, is superimposed on the overall image 301 (see FIG. 13). The “registered tray” is a tray that has already been registered by the setting system 10. If the “registered tray” is selected on the selection window 303, then an overall image 301 covering the registered tray 28 and a group of indicators 31 corresponding to the registered tray 28 are displayed in the first display region R1 as shown in FIG. 12. If any of the inspection areas A1 is selected on the overall image 301, then an inspection image 302 covering the inspection area A1 thus selected is displayed in the second display region R2.

The “custom tray” allows the user to change the number of rows and the number of columns of the indicators 311 arbitrarily. In addition, the “custom tray” also allows the user to select the arrangement pattern of the tray 28. In FIG. 12, a first entry field 3031 allowing the user to enter the number of rows of the indicators 311, a second entry field 3032 allowing the user to enter the number of columns of the indicators 311, and a selection field 3033 allowing the user to select an arrangement pattern of the indicators 311 are provided. In FIG. 12, the selection field 3033 allows the user to select any desired arrangement pattern from “grid,” “hound's tooth #1,” “hound's tooth #2,” or “full custom.” That is to say, the setting system 10A according to the second embodiment allows the user to select the arrangement pattern of the plurality of indicators 311 included in the group of indicators 31 from the plurality of selection patterns. Specifically, the “hound's tooth #1” is an arrangement pattern forming a hound's tooth pattern in the row direction (i.e., vertically) while the “hound's tooth #2” is an arrangement pattern forming a hound's tooth pattern in the column direction (i.e., horizontally).

In the fourth display region R4, a height entry window 304 allowing the user to enter the height of the object under test B1 is displayed. The height entry window 304 includes an entry field 3041. The user enters the height (e.g., 50 mm in FIG. 12) of the object under test B1 into the entry field 3041 by using the input device 2. This enables regulating the movement of the inspection camera 23A, for example, in the height direction (i.e., the upward/downward. direction) to prevent the inspection camera 23A from coming into contact with the object under test B1.

In the fifth display region R5, an illuminance settings window 305 allowing the user to set the illuminance of the stage light 24A is displayed. The illuminance settings window 305 includes an adjustment bar 3051. The user may set (adjust) the illuminance of the stage light 24A by moving the adjustment bar 3051 up and down with the input device 2A. In FIG. 12, the illuminance of the stage light 24A is set at 50%.

The appearance inspection machine 300A according to the second embodiment displays, when a particular inspection area A1 is selected from the plurality of inspection areas A1 on the overall image 301 included in the settings window 30 (see FIG. 12) displayed on the display device 4A, an image of that inspection area A1 on the display device 4A.

### (4) Exemplary Operation

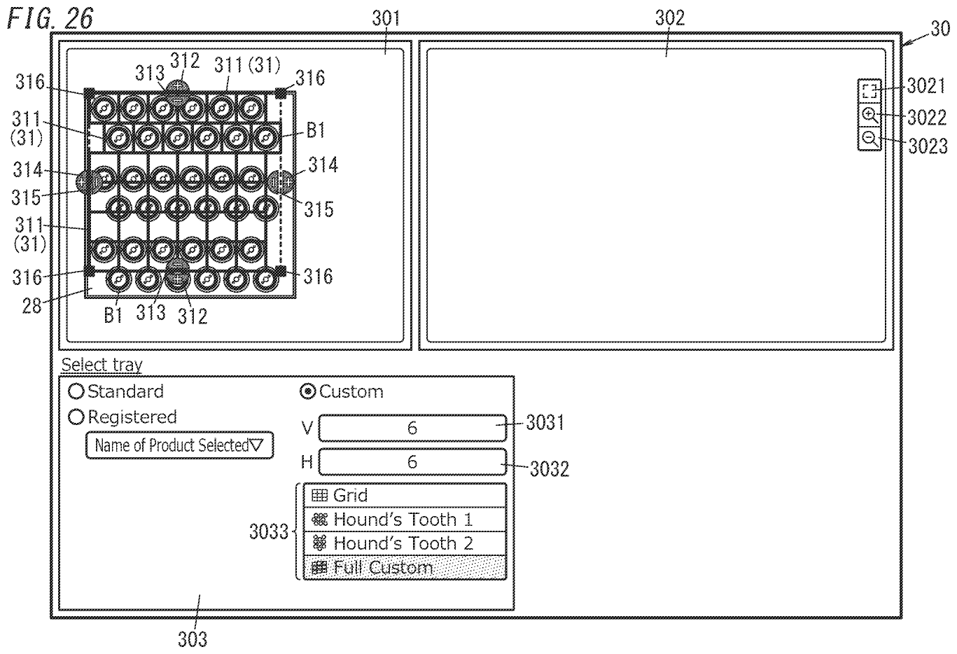

Next, an exemplary operation of the setting system 10A according to the second embodiment will be described with reference to FIGS. 13-30. Note that in FIGS. 13 and 14 and FIGS. 16-30, illustration of the height entry window 304 and the illuminance settings window 305 is omitted.

### (4.1) First Exemplary Operation

First, a first exemplary operation of the setting system 10A will be described with reference to FIGS. 13-18.

In a state where no tray is selected on the selection window 303 (i.e., in a default state), the “standard tray” is selected by default as shown in FIG. 13. In that case, a group of indicators 31 forming a matrix of six rows by seven columns is superimposed on the overall image 301. In FIG. 13, the plurality of indicators 311 included in the group of indicators 31 are arranged regularly.

In addition, at each of two end portions of the group of indicators 31 in the row direction (i.e., in the vertical direction), a row plus button 312 and a row minus button 313 are displayed. On the other hand, at each of two end portions of the group of indicators 31 in the column direction (i.e., in the horizontal direction), a column plus button 314 and a column minus button 315 are displayed. The row plus button 312 is a button for use to add a row and the row minus button 313 is a button for use to delete a row. The column plus button 314 is a button for use to add a column and the column minus button 315 is a button for use to delete a row in addition, at each of the four comers of the group of indicators 31, a zoom up/down button 316 for use to zoom up or down the group of indicators 31 is displayed.

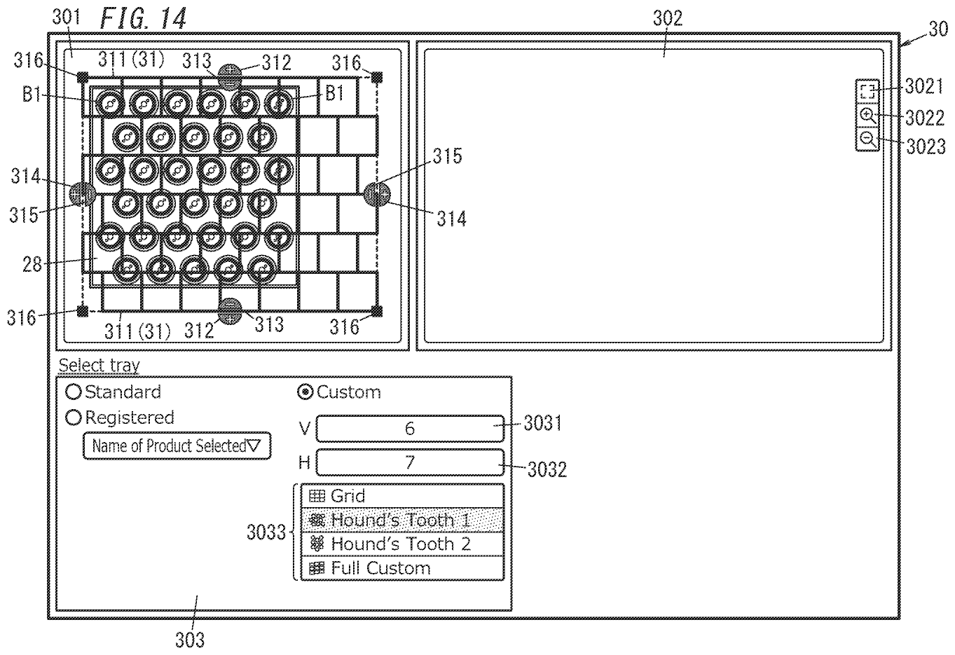

In the tray 28, on the other hand, a row on which six objects under test B1 are arranged side by side in the column direction (i.e., horizontally) alternates in the row direction (i.e., vertically) with a row on which five objects under test B1 are arranged side by side in the column direction. That is to say, according to the first exemplary operation, the objects under test B1 are arranged in a hound's tooth pattern in the row direction, and therefore, cannot be processed with the “standard tray.” Thus, according to the first exemplary operation, the “custom tray” is selected and “hound's tooth #1” is selected as the arrangement pattern of the indicators 311 on the selection window 303 as shown in FIG. 14. In that case, a group of indicators 31 forming a matrix of six rows by seven columns, for example, may be superimposed on the overall image 301. The plurality of indicators 311 included in the group of indicators 31 are arranged regularly as shown in FIG. 14.

As shown in FIG. 14, simply selecting “hound's tooth #1” as the arrangement pattern does not bring the number of the objects under test B1 into agreement with the number of the indicators 311 and does not bring the locations of the indicators 311 into agreement with the locations of the objects under test B1. Thus, in that state, the number and locations of the indicators 311 need to be adjusted (set). Its procedure will be described below In the following description, the “row direction” will be hereinafter referred to as the “upward/downward direction” and the “column direction” will be hereinafter referred to as the “rightward/leftward direction.”

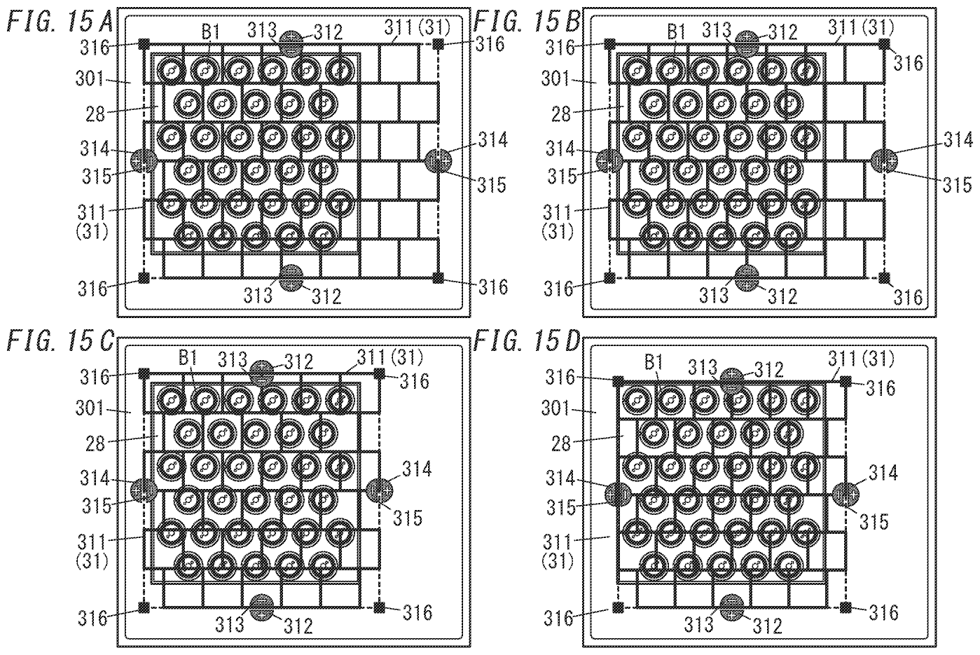

The user presses the column minus button 315 on the right once on the overall image 301 shown in FIG. 15A. As a result, one column is deleted from the group of indicators 31 as shown in FIG. 15B. The user further presses the column minus button 315 on the right twice on the overall image 301 as shown in FIG. 15B. As a result, two columns are deleted from the group of indicators 31 as shown in FIG. 15C. This brings the number of the objects under test B1 held in the tray 28 into agreement with the number of the indicators 311 included in the group of indicators 31. As described above, in the setting system 10A according to the second embodiment, the plurality of indicators 311 included in the group of indicators 31 may be increased and decreased on a row-by-row basis and/or on a column-by-column basis.

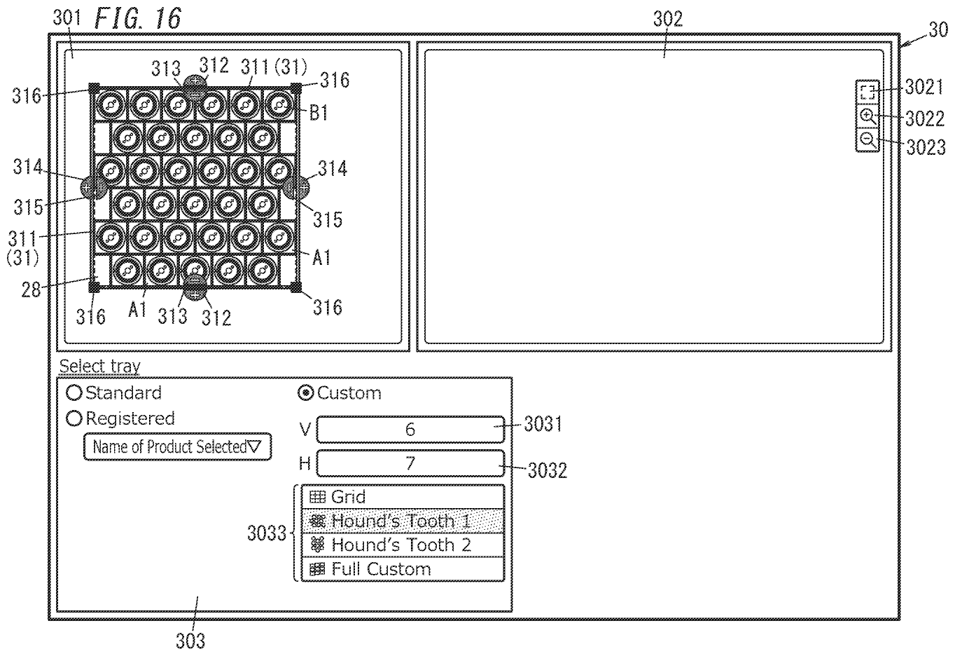

Furthermore, the user moves, on the overall image 301 shown in FIG. 15C, the zoom up/down button 316 located at the upper left corner of the group of indicators 31 to a location where the zoom up/down button 316 overlaps with the upper left corner of the tray 28 by dragging the zoom up/down button 316, thereby brining the zoom up/down button 316 into agreement with the upper left corner of the tray 28 (see FIG. 15D). Thereafter, the user moves, on the overall image 301 shown in FIG. 15D, the zoom up/down button 316 located at the lower right corner of the group of indicators 31 to a location where zoom up/down button 316 overlaps with the lower right corner of the tray 28 by dragging the zoom up/down button 316, thereby brining the zoom up/down button 316 into agreement with the lower right corner of the tray 28 (see FIG. 16). In this manner, the respective locations and sizes of the indicators 311 are adjusted (set) such that the respective objects under test B1 fall within the frames of their corresponding indicators 311. The respective indicators 311 thus adjusted are registered as the inspection areas A1 corresponding to the respective objects under test B1.

In the example described above, the zoom up/down button 316 is moved to a location where the zoom up/down button 316 overlaps with the upper left corner of the tray 28. However, this is only an example and should not be construed as limiting. Alternatively, the zoom up/down button 316 may also be moved to the vicinity of the upper left corner of the tray 28 such that the zoom up/down button 316 and the upper left corner of the tray 28 substantially agree with each other. The same statement applies to the lower right corner of the tray 28 as well and will also apply to similar situations to be described in the following description.

Note that when “hound's tooth #2” that causes the indicators 311 to be arranged in a. hound's tooth pattern in the column direction (i.e., horizontally) is selected, rows of the group of indicators 31 may be increased and decreased with the row plus button 312 and the row minus button 313, instead of increasing and decreasing columns of the group of indicators 31 with the column plus button 314 and the column minus button 315. This may bring the number of the objects under test B1 into agreement with the number of the indicators 311. The rest of the operation will be the same as in the situation where “hound's tooth #1” is selected.

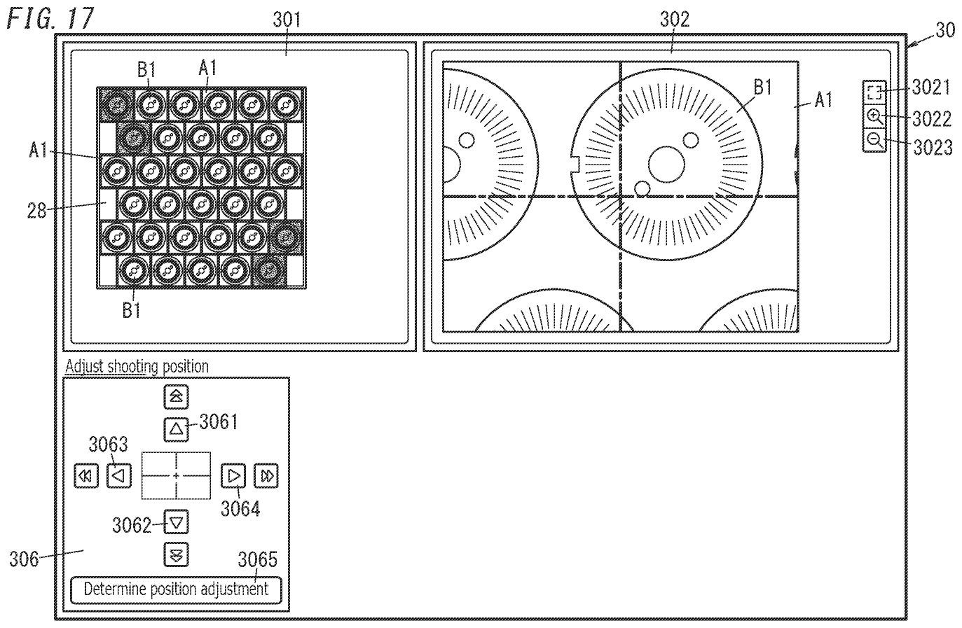

When any of the inspection areas A1 is selected on the overall image 301 displayed in the first display region R1, an inspection image 302 covering the inspection area A1 selected is displayed in the second display region R2 as shown in FIG. 17. In that case, an adjustment window 306 for adjusting the shooting position of the inspection camera 23A is displayed as well. The adjustment window 306 includes an UP button 3061, a DOWN button 3062, a LEFT button 3063, a RIGHT button 3064, and an ENTER button 3065. The UP button 3061 is a button for use to move the shooting position of the inspection camera 23A upward. The DOWN button 3062 is a button for use to move the shooting position of the inspection camera 23A downward. The LEFT button 3063 is a button for use to move the shooting position of the inspection camera 23A to the left. The RIGHT button 3064 is a button for use to move the shooting position of the inspection camera 23A to the right. The ENTER button 3065 is a button for use to determine the shooting position of the inspection camera 23A at the position thus adjusted.

According to the first exemplary operation, the processing of brining the zoom up/down button 316 located at the upper left corner of the group of indicators 31 into agreement with the upper left corner of the tray 28 and the processing of brining the zoom up/down button 316 located at the lower right corner of the group of indicators 31 into agreement with the lower right corner of the tray 28 are performed by the user intuitively. Thus, an object under test B1 may be misaligned with the center of the inspection image 302 as shown in FIG. 17. In addition, a distortion error and/or a mechanical error of the inspection camera 23A may also be involved with this misalignment. The setting system 10A according to the second embodiment may make correction to this misalignment. That is to say, the setting system 10A according to the second embodiment may make, based on the inspection image 302 included in the settings window 30, correction to the inspection area A1 registered. Its procedure will be described below. Note that in the case of the hound's tooth pattern adopted in the first exemplary operation, making correction to two indicators 311 located at the upper left corner and two indicators 311 located at the lower right corner (i.e., the dotted ones in FIG. 17), out of the plurality of indicators 311 included in the group of indicators 31 as shown in FIG. 17 enables making correction to all indicators 311 included in the group of indicators 31.

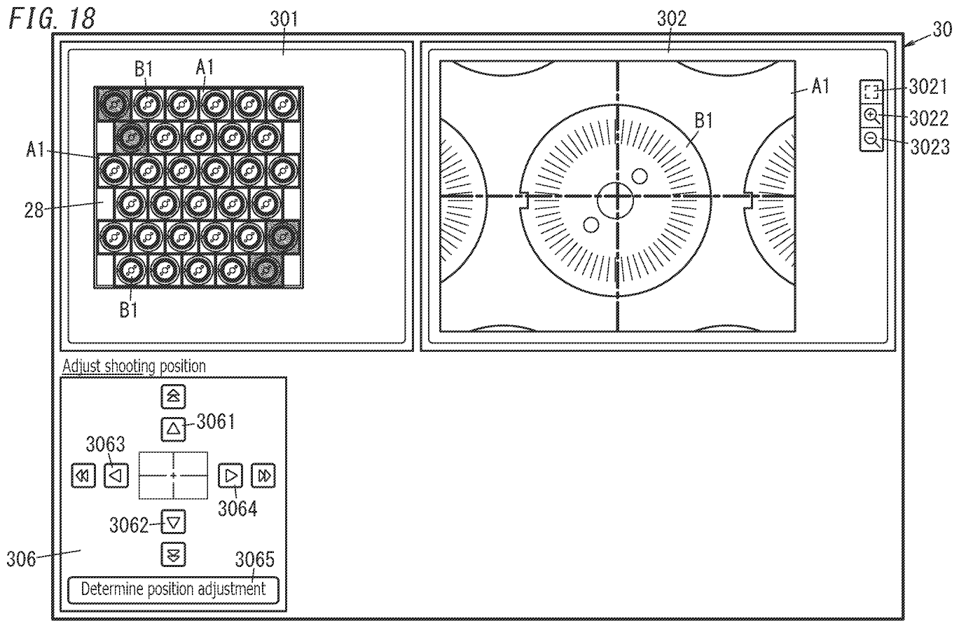

The user presses, while watching the inspection image 302 displayed in the second display region R2, at least one of the UP button 3061, the DOWN button 3062, the LEFT button 3063, or the RIGHT button 3064 to move the object under test B1 to around the center of the inspection image 302. Then, in a state where the object under test B1 is located around the center of the inspection image 302 as shown in FIG. 18, the user presses the ENTER button 3065. This allows correction to one inspection area A1 located at the upper left corner (stated otherwise, adjustment of the shooting position of the inspection camera 23A corresponding to the inspection area A1) to be done. The user performs the above-described processing on each of the two indicators 311 located at the upper left corner and the two indicators 311 located at the lower right corner.

### (4.2) Second Exemplary Operation

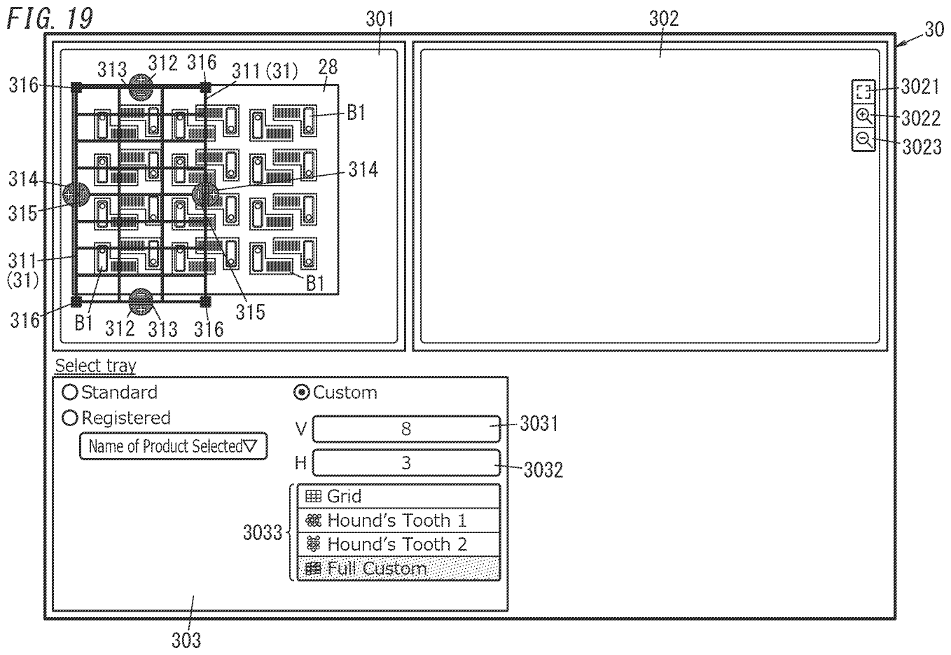

Next, a second exemplary operation of the setting system 10A will be described with reference to FIGS. 19-22.

In the second exemplary operation, the “custom tray” is selected, and “full custom” is selected as the arrangement pattern of the indicators 311 on the selection window 303 as shown in FIG. 19. In that case, a group of indicators 31 forming a matrix of eight rows by three columns, for example, is superimposed on the overall image 301. In FIG. 19, the plurality of indicators 311 included in the group of indicators 31 are arranged regularly. In addition, row plus buttons 312, row minus buttons 313, column plus buttons 314, column minus buttons 315, and zoom up/down buttons 316 are also superimposed on the overall image 301. That is to say, according to this second exemplary operation, the plurality of indicators 311 included in the group of indicators 31 may also be increased and decreased on a row-by-row basis and/or on a column-by-column basis.

In the tray 28, on the other hand, multiple pairs of objects under test B1 are arranged such that four pairs are arranged in the row direction (i.e., vertically) and three pairs are arranged in the column direction (i.e., horizontally). According to this second exemplary operation, a slit portion (see FIG. 19) of each object under test B1 needs to be inspected. Furthermore, although the number of the objects under test B1 agrees with the number of the indicators 311 according to this second exemplary operation, the locations of the respective indicators 311 need to be adjusted (set). Its procedure will be described below. In the following description, the “row direction” will be hereinafter referred to as the “upward/downward direction” and the “column direction” will be hereinafter referred to as the “rightward/leftward direction.”

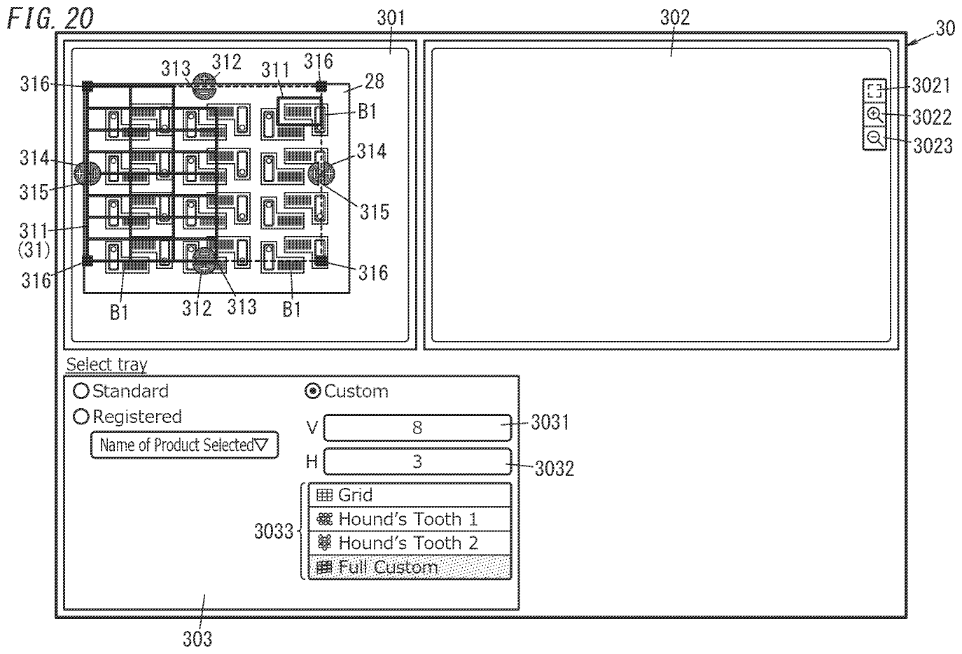

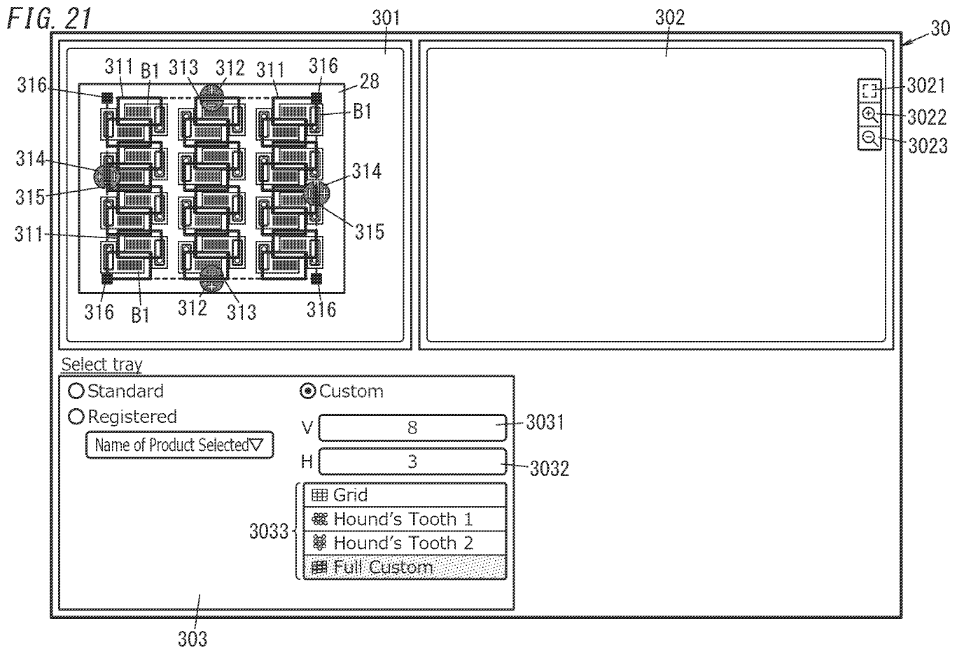

The user moves, to the right, the zoom up/clown button 316 located at either the upper right corner or the lower right corner of the group of indicators 31 while dragging the zoom up/down button 316, thereby expanding the region of the group of indicators 31 (as partially indicated by the dashed line in FIG. 20) to an appropriate degree. Thereafter, the user sequentially drags the plurality of indicators 311 included in the group of indicators 31, thereby moving the indicators 311 such that the slit portion (object to be inspected) of each object under test B1 falls within the frame of its corresponding indicator 311 (see FIGS. 20 and 21). In a state where all indicators 311 have been moved, the indicators 311 adjacent to each other in the upward/downward direction partially overlap with each other as shown in FIG. 21. Optionally, the respective sizes of the indicators 311 may be adjusted such that the indicators 311 adjacent to each other in the upward/downward direction do not overlap with each other.

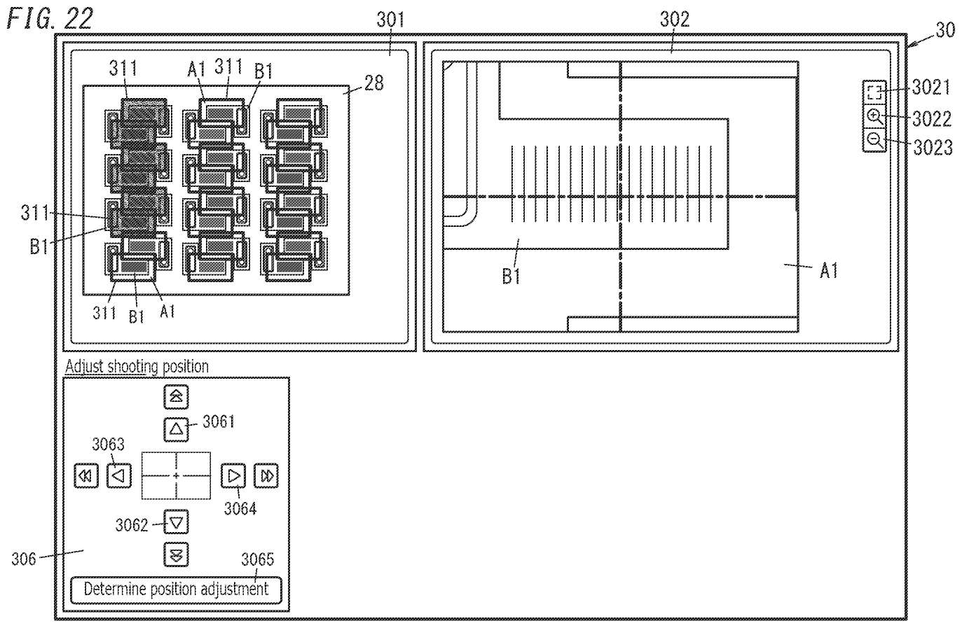

In this second exemplary operation, when any of the indicators 311 (or inspection areas A1) superimposed on the overall image 301 is selected, an inspection image 302 corresponding to the indicator 311 selected is displayed as in the first exemplary operation in the second display region R2 as shown in FIG. 22. In addition, in this second exemplary operation, an adjustment window 306 for use to adjust the shooting position of the inspection camera 23A is also displayed (see FIG. 22). That is to say, according to this second exemplary operation, adjusting the shooting position of the inspection camera 23A enables making correction to the inspection area. A1.

The user presses, while watching the inspection image 302 displayed in the second display region R2, at least one of the UP button 3061, the DOWN button 3062, the LEFT button 3063, or the RIGHT button 3064 to move the slit portion (object to be inspected) of the object under test B1 to around the center of the inspection image 302. Then, in a state where the slit portion of the object under test B1 is located around the center of the inspection image 302 as shown in FIG. 22, the user presses the ENTER button 3065. This allows correction to the inspection area A1 (in other words, the adjustment of the shooting position of the inspection camera 23A corresponding to the inspection area A1) to be done. According to the second exemplary operation, the respective locations of the indicators 311 are adjusted on an individual basis. Thus, the user performs the above-described processing on every one of the indicators 311 (i.e., every inspection area A1).

### (4.3) Third Exemplary Operation

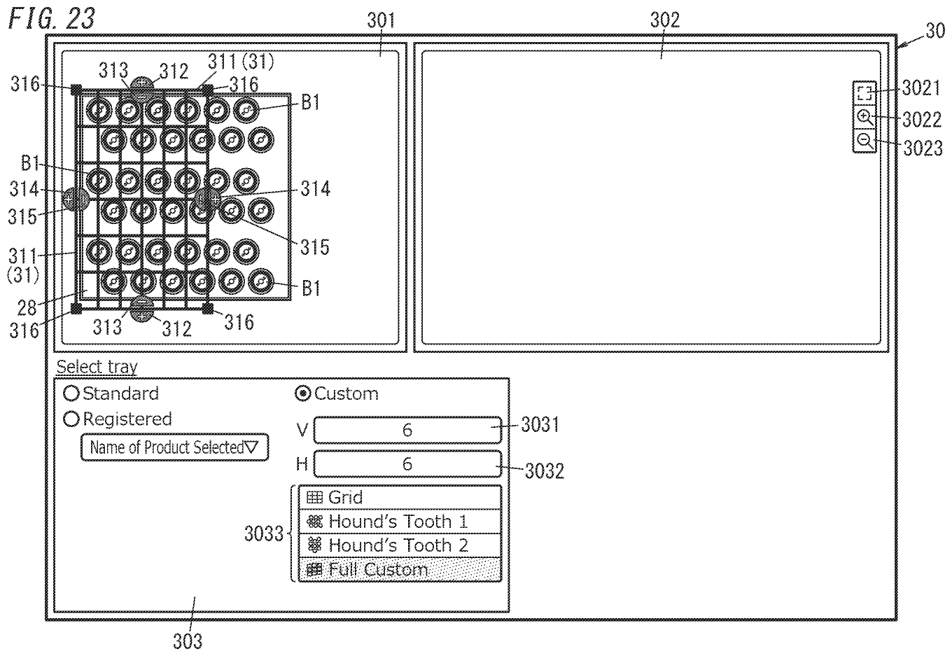

Next, a third exemplary operation of the setting system 10A will be described with reference to FIGS. 23-28.

In the third exemplary operation, the “custom tray” is selected, and “full custom” is selected as the arrangement pattern of the indicators 311 on the selection window 303 as shown in FIG. 23. In that case, a group of indicators 31 forming a matrix of six rows by six columns is superimposed on the overall image 301. As shown in FIG. 23, the plurality of indicators 311 included in the group of indicators 31 are arranged regularly. In addition, row plus buttons 312, row minus buttons 313, column plus buttons 314, column minus buttons 315, and zoom up/down buttons 316 are also superimposed on the overall image 301. That is to say, according to this third exemplary operation, the plurality of indicators 311 included in the group of indicators 31 may also be increased and decreased on a row-by-row basis and/or on a column-by-column basis.

In the tray 28, on the other hand, multiple pairs of rows, on each of which six objects under test B1 are arranged side by side in the column direction (i.e., horizontally), are arranged to form a hound's tooth pattern in the row direction (i.e., vertically), and three pairs of such rows are arranged to be spaced from each other in the row direction as shown in FIG. 23. Although the number of the objects under test B1 agrees with the number of the indicators 311 included in the group of indicators 31 according to this third exemplary operation, the locations of the respective indicators 311 need to be adjusted (set). Its procedure will be described below. In the following description, the “row direction” will be hereinafter referred to as the “upward/downward direction” and the “column direction” will be hereinafter referred to as the “rightward/leftward direction.”

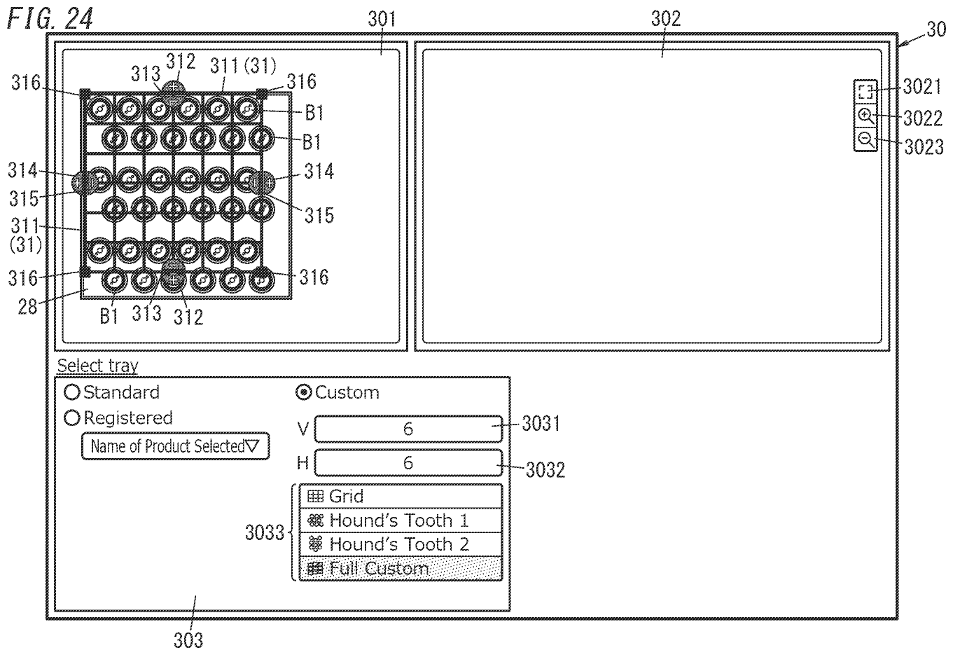

The user moves the group of indicators 31 such that the first column of six objects under test B1 fall within the respective frames of the first column of six indicators 311. Specifically, the user moves the group of indicators 31 to a location where the zoom up/down button 316 located at the upper left corner of the group of indicators 31 agrees with the upper left corner of the tray 28 by dragging the zoom up/down button 316. Thereafter, the user moves the zoom up/down button 316 located at the upper right corner of the group of indicators 31 to a location where each object under test B1 falls within the frame of its corresponding indicator 311 by dragging the zoom up/down button 316. As a result, the six objects under test B1 on the first column fall within the respective frames of the six indicators 311 on the first column as shown in FIG. 24.

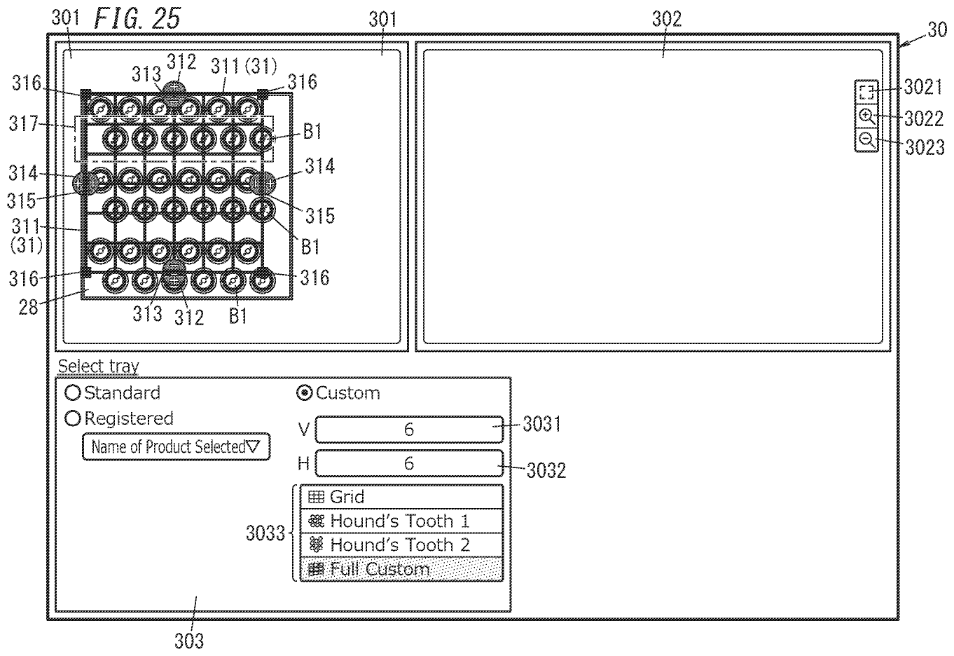

Next, the user performs the processing of dividing the six indicators 311 on the second column such that the six objects under test B1 on the second column fall within the respective frames of the six indicators 311 on the second column. Specifically, the user selects a division range 317 that includes the six indicators 311 on the second column as shown in FIG. 25. As a result, the six indicators 311 on the second column are divided and made freely movable. Then, the user moves the six indicators 311 on the second column to the right such that the six objects under test B1 on the second column respectively fall within the six indicators 311 on the second column. Note that the respective sizes of the indicators 311 have been adjusted for the first column, and therefore, do not have to be adjusted for the second column.

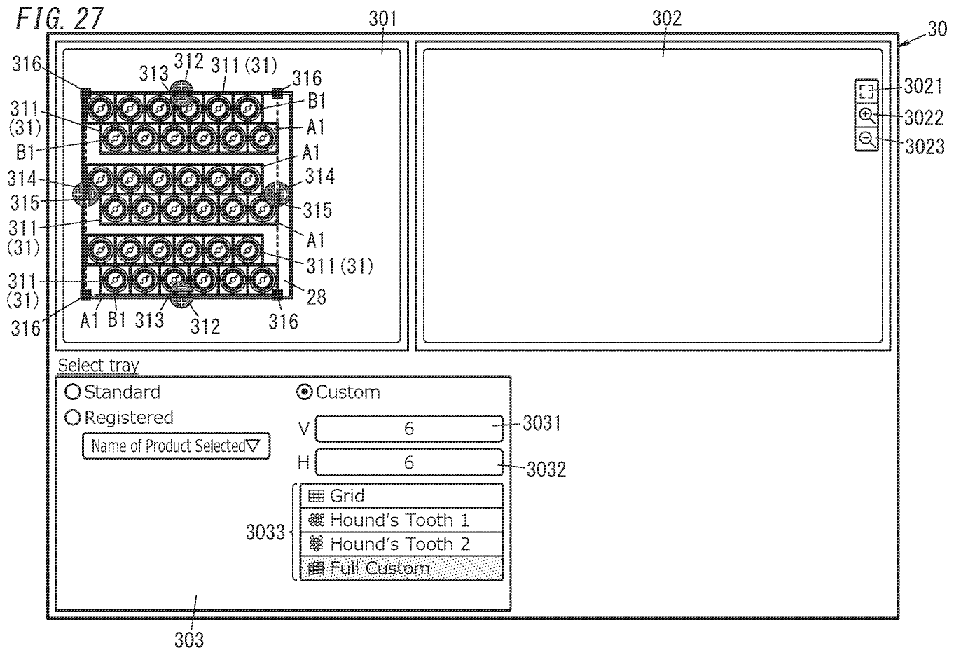

The user performs the division processing in the same way on the third column and on and then moves the six indicators 311 on each column such that the six objects under test B1 on each column respectively fall within the six indicators 311 on the corresponding column. As a result, the six objects under test B1 on every column will fall within the indicators 311 on the corresponding column as shown in FIG. 27. Note that from the third column and on, as well as on the second column, the sizes of the indicators 311 do not have to be adjusted. Optionally, a plurality of columns may be selected and moved at a time.

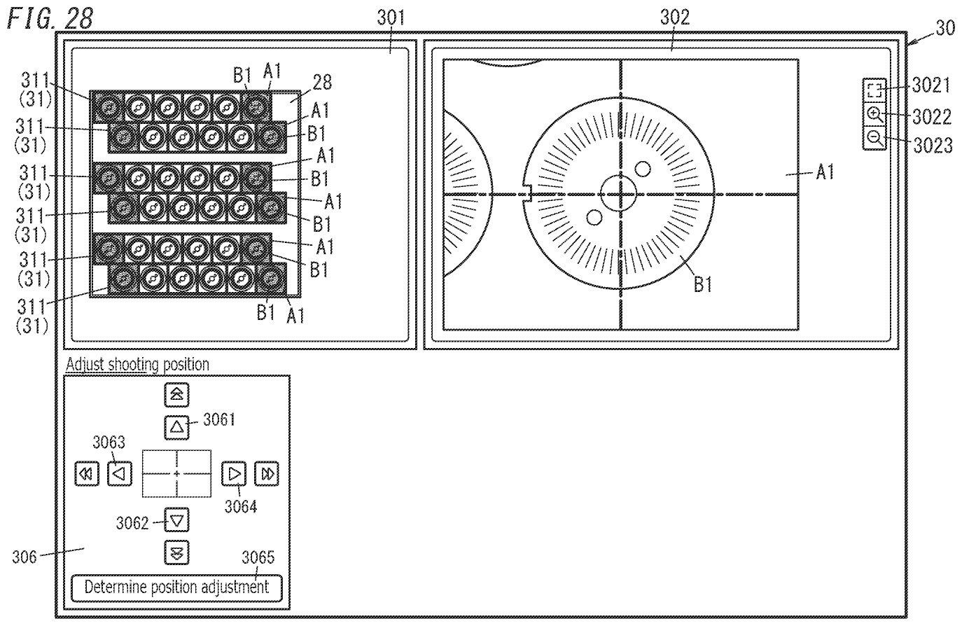

According to the third exemplary operation, the user performs the processing of moving six indicators 311 intuitively on a column-by-column basis, and therefore, the shooting position of the inspection camera 23A needs to be adjusted on a column-by-column basis. Specifically, the user adjusts the shooting position of the inspection camera 23A for two indicators 311 located at both ends on a column-by-column basis (the dotted ones in FIG. 28). This enables making correction to the inspection areas A1.

The user presses, while watching the inspection image 302 displayed in the second display region R2, at least one of the UP button 3061, the DOWN button 3062, the LEFT button 3063, or the RIGHT button 3064 to move the object under test B1 to around the center of the inspection image 302. Then, in a state where the object under test B1 is located around the center of the inspection image 302 as shown in FIG. 28, the user presses the ENTER button 3065. This allows correction to the inspection area A1 (in other words, adjustment of the shooting position of the inspection camera 23A corresponding to the inspection area A1) to be done. According to the third exemplary operation, the user performs the above-described processing on the two indicators 311 located at both ends on a column-by-column basis.

### (4.4) Fourth Exemplary Operation

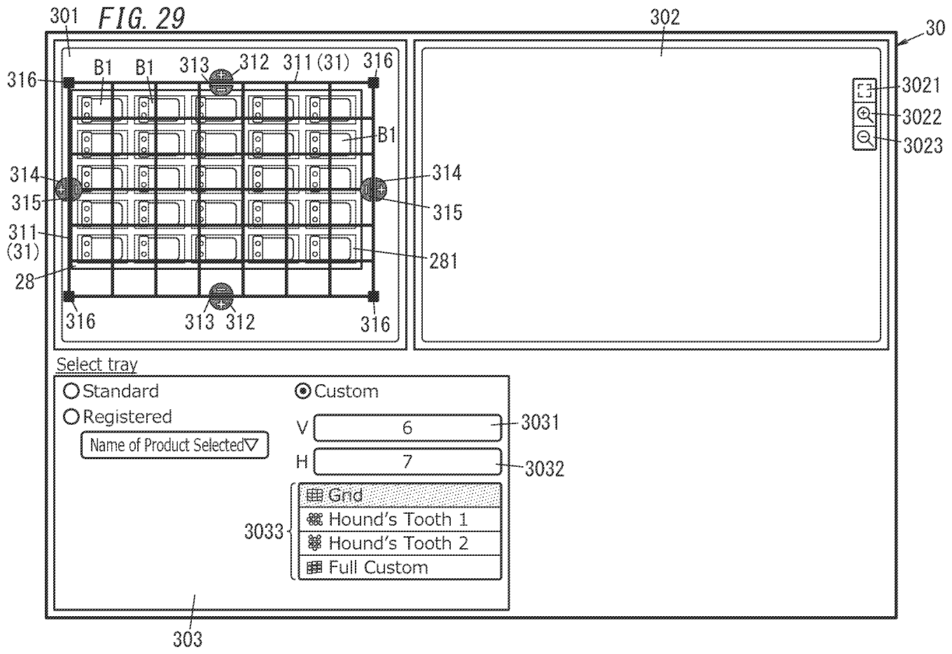

Next, a fourth exemplary operation of the setting system 10A will be described with reference to FIG. 29.

In the fourth exemplary operation, the “custom tray” is selected, and “grid” is selected as the arrangement pattern of the indicators 311 on the selection window 303 as shown in FIG. 29. In that case, a group of indicators 31 forming a matrix of six rows by seven columns is superimposed on the overall image 301. The plurality of indicators 311 included in the group of indicators 31 are arranged regularly as shown in FIG. 29. In addition, row plus buttons 312, row minus buttons 313, column plus buttons 314, column minus buttons 315, and zoom up/down buttons 316 are also superimposed on the overall image 301. That is to say, according to this fourth exemplary operation, the plurality of indicators 311 included in the group of indicators 31 may also be increased and decreased on a row-by-row basis and/or on a column-by-column basis.

Note that the processing of adding or deleting a row or a column, the processing of zooming up or down the group of indicators 31 using the zoom up/down buttons 316, the processing of moving the group of indicators 31 such that the respective objects under test Bi fall within their corresponding indicators 311, and other types of processing are performed in the same way as in the first exemplary operation described above, and therefore, description thereof will be omitted herein.

### (5) Advantages

The setting system 10A according to the second embodiment superimposes each indicator 311 on the overall image 301 shot with the stage camera 22A of the appearance inspection machine 300A and sets the inspection area A1 according to the location of the indicator 311. Thus, the inspection area A1 may be set just by moving the indicator 311 with respect to the overall image 301 such that a corresponding object under test B1 falls within the frame of each indicator 311. That is to say, the setting system 10A according to the second embodiment allows the inspection area A1 to be set easily, thus enabling setting the inspection area A1 suitably applicable to general-purpose appearance inspection.

In addition, the setting system 10A according to the second embodiment allows the user to enter the inspection area A1 intuitively, thus achieving the advantage of facilitating learning and requiring no expertise. Furthermore, the setting system 10A according to the second embodiment superimposes the indicator 311 on a real image (overall image 301), thus requiring no detailed settings and eliminating input errors as well.

### (6) Variations

Note that the second embodiment described above is only an exemplary one of various embodiments of the present disclosure and should not be construed as limiting. Rather, the second embodiment may be readily modified in various manners depending on a design choice or any other factor without departing from the scope of the present disclosure. Also, the functions of the setting system 10A according to the second embodiment may also be implemented as, for example, a setting method, a computer program, or a non-transitory storage medium that stores a computer program thereon.

A setting method according to an aspect is method applicable to an appearance inspection machine 300A to perform appearance inspection on an object under test B1 falling within an inspection area A1 based on an inspection image 302 covering the inspection area A1. The setting method includes making settings of the inspection area A1 on a settings window 30 displayed on a display device 4A (display unit). The settings window 30 includes an overall image 301 covering a plurality of inspection areas A1 and an indicator 311 superimposed on the overall image 301. The setting method includes a registration step. The registration step includes registering the plurality of inspection areas A1 according to location of the indicator 311 on the settings window 30.

A program according to another aspect is applicable to a setting system 10A for use in an appearance inspection machine 300. A to perform appearance inspection on an object under test B1 falling within an inspection area A1 based on an inspection image 302 covering the inspection area A1. The setting system 10A is configured to make settings of the inspection area A1 on a settings window 30 displayed on a display device 4A (display unit). The settings window 30 includes an overall image 301 covering a plurality of inspection areas A1 and an indicator 311 superimposed on the overall image 301. The program is designed to cause one or more processors for use in the setting system 10A to serve as a registration unit 11A. The registration unit 11A registers the plurality of inspection areas A1 according to location of the indicator 311 on the settings window 30.

Next, variations of the second embodiment will be enumerated one after another. Optionally, the variations to be described below may be adopted in combination as appropriate.

### (6.1) First Variation

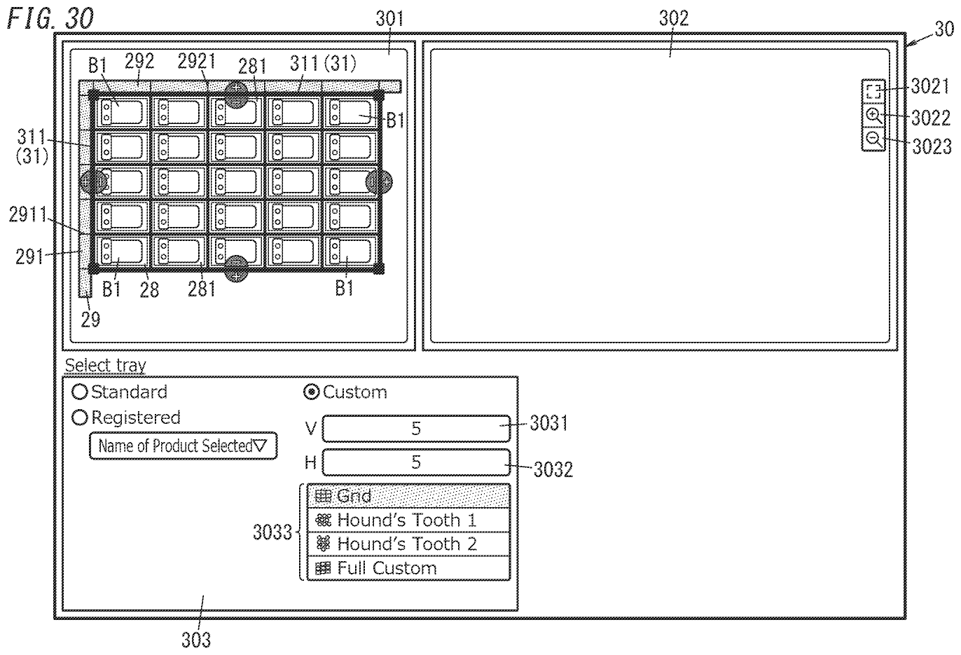

According to the second embodiment, the user sets the inspection areas A1 by intuitively moving the group of indicators 31 superimposed on the overall image 301. Alternatively, a guide 29 may be used as shown in FIG. 30. A setting system 10A according to the first variation will now be described with reference to FIG. 30. Except the guide 29, the setting system 10A according to the first variation has the same configuration as the setting system 10A according to the second embodiment. Thus, description of their common constituent elements other than the guide 29 will be omitted herein.

The setting system 10A according to the first variation includes the control device 1A, the input device 2A, and the display device 4A. The setting system 10A according to the first variation further includes the guide 29 as shown in FIG. 30. The control device 1A includes the registration unit 11A, the storage unit 12A, and the external I/F 13A.

The guide 29 is formed in an L-shape including a first part 291 extending in the row direction (i.e., vertically) and a second part 292 extending in the column direction (i.e., horizontally). The first part 291 has a plurality of first scales 2911, which are provided at regular intervals along the length of the first part 291. The second part 292 has a plurality of second scales 2921, which are provided at regular intervals along the length of the second part 292. The interval between the first scales 2911 is approximately equal to the dimension in the row direction (i.e., vertical dimension) of each holding space 281 of the tray 28. The interval between the second scales 2921 is approximately equal to the dimension in the column direction (i.e., horizontal dimension) of each holding space 281 of the tray 28.

In the setting system 10A according to the first variation, when the display screen of the display device 4A is switched to the settings window 30, the first scales 2911 and the second scales 2921 provided for the guide 29 are recognized automatically, thus generating a group of indicators 31 according to the first scales 2911 and the second scales 2921. Thus, the setting system 10A according to the first variation automatically sets an indicator 311 for setting the inspection area A1. The user just needs to sequentially select, one after another, the plurality of indicators 311 that have been set automatically to see if each object under test B1 is located around the center of the inspection image 302.

The setting system 10A according to the first variation makes it even easier to set the inspection area A1.

### (6.2) Second Variation

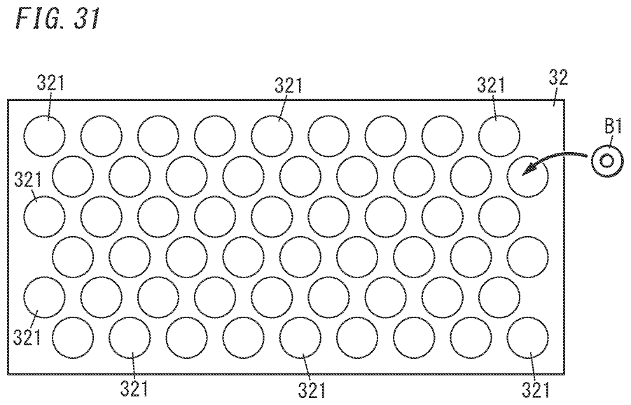

In the second embodiment and first variation described above, the objects under test B1 are held in the tray 28. Alternatively, a setting member 32 for setting the inspection areas A1 may also be used as shown in FIG. 31. A setting system 10A according to a second variation will now be described with reference to FIG. 31. Except that the setting member 32 is used, the setting system 10A according to the second variation has the same configuration as the setting system 10A according to the second embodiment. Thus, description of their common constituent elements other than the setting member 32 will be omitted herein.

The setting system 10A according to the second variation includes the control device 1A, the input device 2A, and the display device 4A. The setting system 10A according to the second variation further includes the setting member 32 as shown in FIG. 31. The control device 1A includes the registration unit 11A, the storage unit 12A, and the external I/F 13A.

The setting system 10A according to the second variation uses the setting member 32 instead of the tray 28 as shown in FIG. 31. When viewed in plan, the setting member 32 has a rectangular shape, which is elongate in one direction (i.e., the rightward/leftward direction in FIG. 31). The setting member 32 is provided with a plurality of pattern elements 321. Each of the plurality of pattern elements 321 may be circular, for example, and large enough to hold an object under test B1. Also, a material for the setting member 32 may be, but does not have to be, paper, for example.

In the setting system 10A according to the second variation, the setting member 32 may be affixed, with an adhesive tape, for example, onto the mounting surface (upper surface) of the stage 27. In addition, the objects under test BI are put on the setting member 32 so as to fall within the respective frames of the pattern elements 321 of the setting member 32.

In the setting system 10A according to the second variation, when the display screen of the display device 4A is switched to the settings window 30, the respective pattern elements 321 of the setting member 32 are recognized automatically as inspection areas A1. Thus, the setting system 10A according to the second variation also allows the inspection areas A1 to be set automatically.

### (6.3) Third Variation

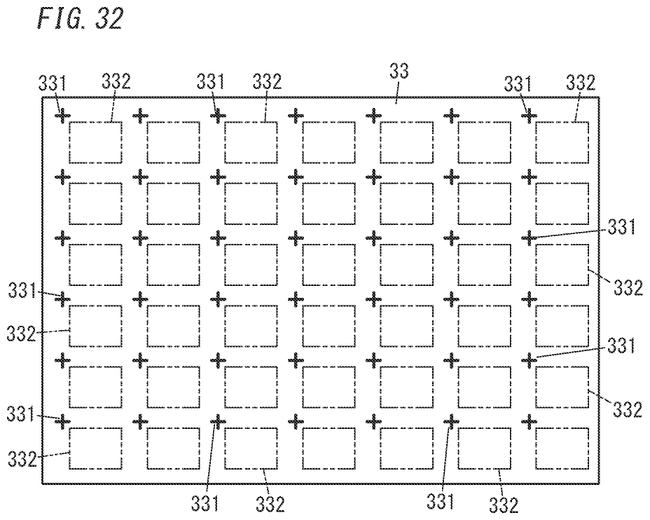

In the second embodiment and first variation described above, the objects under test B1 are held in the tray 28. Alternatively, a setting member 33 for setting the inspection areas A1 may also be used as shown in FIG. 32. A setting system 10A according to a third variation will now be described with reference to FIG. 32. Except that the setting member 33 is used, the setting system 10A according to the third variation has the same configuration as the setting system 10A according to the second embodiment. Thus, description of their common constituent elements other than the setting member 33 will be omitted herein.

The setting system 10A according to the third variation includes the control device 1A, the input device 2A, and the display device 4A. The setting system 10A according to the third variation further includes the setting member 33 as shown in FIG. 32. The control device 1A includes the registration unit 11A, the storage unit 12A, and the external I/F 13A.

The setting system 10A according to the third variation uses the setting member 33 instead of the tray 28 as shown in FIG. 32. When viewed in plan, the setting member 33 has a rectangular shape, which is elongate in one direction (i.e., the rightward/leftward direction in FIG. 32). The setting member 33 is provided with a plurality of signs 331. Each of the signs 331 may be, but does not have to be, a cross sign. Also, a material for the setting member 33 may be, but does not have to be, paper, for example. Optionally, the tray 28 may also be used as the setting member 33. That is to say, inspection may also be performed with the objects under test put directly on the setting member 33.

Also, according to a method for setting the inspection areas A1 automatically, the inspection areas A1 may be directly estimated from the regular pattern of the tray. If it is difficult to estimate the inspection areas A1 due to, for example, light reflected from the tray, then a method using the setting member may be adopted.

In the setting system 10A according to the third variation, the setting member 33 may be affixed, with an adhesive tape, for example, onto the mounting surface (upper surface) of the stage 27. Also, in the setting system 10A according to the third variation, when the display screen of the display device 4A is switched to the settings window 30, the respective signs 331 of the setting member 33 are recognized automatically to set corresponding areas 332 in the vicinity of the respective signs 331. Then, in the setting system 10A according to the third variation, the respective areas 332 automatically recognized are set as the inspection areas A1. Thus, according to the third variation, using the setting member 33 also allows the inspection areas A1 to be set automatically.

### (6.4) Fourth Variation

In the second embodiment described above, the size of each indicator 311 is set intuitively by the user. Alternatively, if the indicator 311 is aligned with, for example, the centerline of an adjacent holding space 281 of the tray 28 when the size of the indicator 311 reaches a size appropriate for the inspection area A1, then an auxiliary line may be displayed. That is to say, as in the setting system 10A according to the fourth variation, an input support function for supporting the user with input of the indicators 311 may be provided. In that case, the user increases or decreases the size of an indicator 311 superimposed on the overall image 301 and regards the size of the indicator 311 when the auxiliary line is displayed over the indicator 311 as an appropriate size thereof and sets the size of the indicator 311 at the former size. This allows the user to set the size of the indicator 311 at an appropriate one.

### (6.5) Fifth Variation

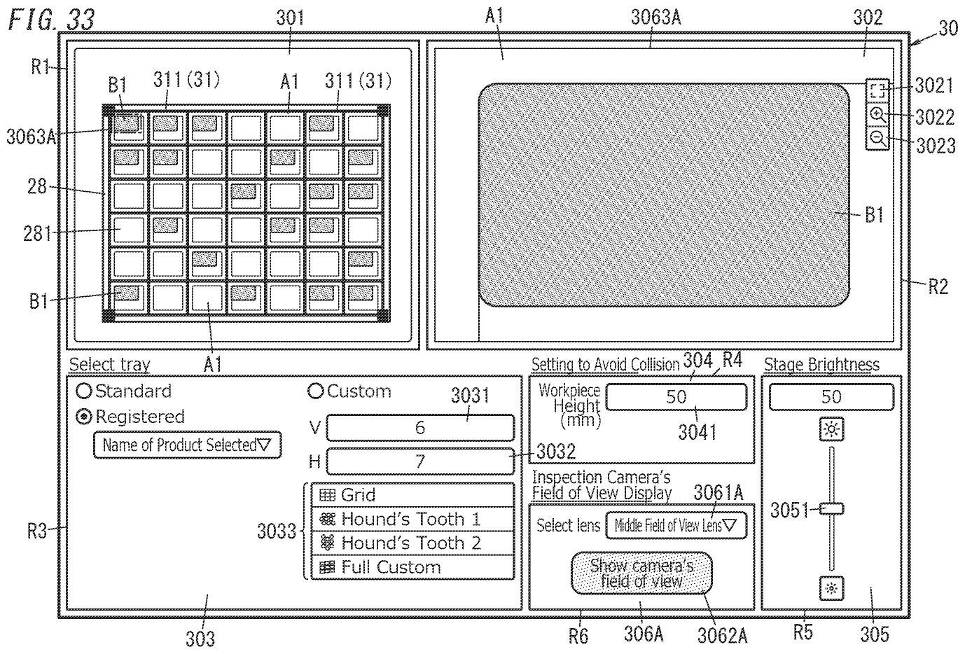

An additional region for selectively showing or hiding the field of view of an inspection camera may also be provided as a sixth display region R6 in addition to the first to fifth display regions R1-R5. FIG. 33 illustrates a settings window 30 including the sixth display region R6. Note that the first to fifth display regions R1-R5 have the same functions as their counterparts already described with reference to FIG. 12 and their description will be omitted herein. The sixth display region R6 is provided under the fourth display region R4.

In the sixth display region R6, an inspection camera field of view display settings window 306A for selectively showing or hiding the field of view of the inspection camera is displayed. When the user selects the attached lens in a selected lens field 3061A and presses a camera field of view display button 3062A, black/white reversal is enabled to cause a field of view frame 3063A corresponding to the selected lens to be displayed as an additional image in the first display region R1. When the user presses the camera field of view display button 3062A again, the black/white reversal is canceled to have the field of view frame 3063A hidden. The relative location of the field of view frame 3063A with respect to the inspection areas A1 may be changed by dragging the field of view frame 3063A with a mouse.

FIG. 33 illustrates a state where the field of view frame 3063A is shown in the first display region R1 with the camera field of view display button 3062A pressed in the sixth display region R6. In the second display region R2, the field of view frame 3063A and an image of the object under test B1 are displayed.

### (6.6) Sixth Variation

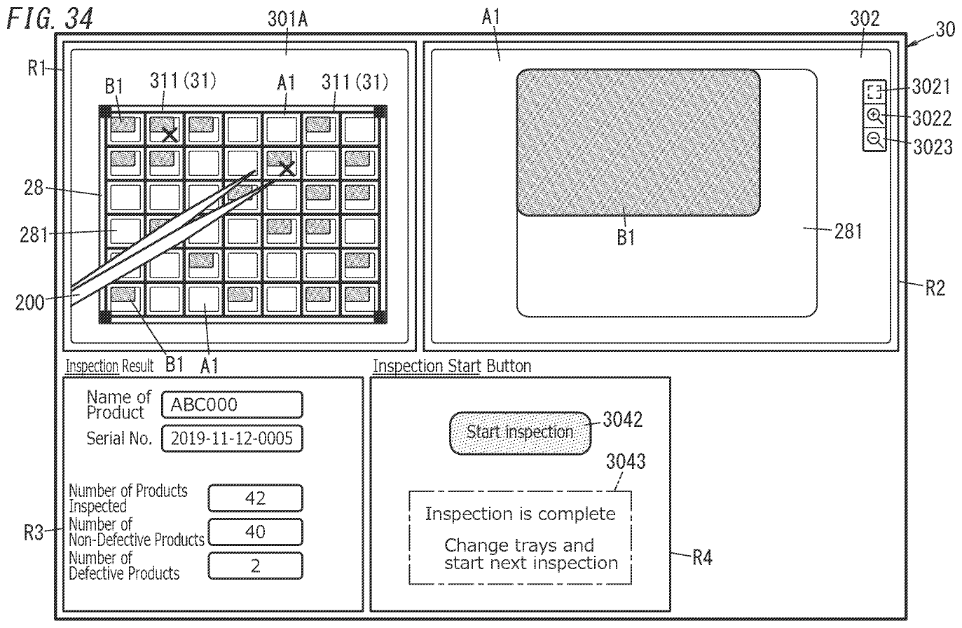

Optionally, the indicator 311 registered at the time of setting may also be used for a purpose other than setting the inspection areas A1. For example, work efficiency may be improved by displaying the indicator 311 superimposed on the overall image 301A at the time of inspection processing. FIG. 34 illustrates a window at a point in time when inspection is finished while the inspection processing is being performed.

The first display region R1, the third display region R3, and the fourth display region R4 are different from their counterparts shown in FIG. 12. Specifically, in the first display region R1, the overall image 301A is displayed and updated into the latest image at regular intervals. In other words, a moving picture is displayed there. In the third display region R3, results of the inspection, specifically, the name of the product tested, the serial number thereof, the number of non-defective products, and the number of defective products, are displayed. In the fourth display region R4, an inspection start button 3042 is displayed and a verbal message 3043 “inspection is complete” indicating the progress of the inspection is also displayed.

On the overall image 301A in the first display region R1, indicators 311 are superimposed. In addition, a cross mark X is also displayed on objects under test B1 that have been determined to be defective products as a result of the inspection. That is to say, the objects under test B1 that have been determined to be defective products as a result of the appearance inspection are displayed in the first display region R1 so as to be distinguishable from the other objects under test B1 that have been determined to be non-defective products as a result of the appearance inspection.

The tester may remove the objects under test B1 that have been determined to be defective products with an image representing a pair of tweezers 200. This allows the tester to remove the defective objects under test B1 while checking their image on a window representing the real products, thus preventing the tester from performing, an erroneous operation.

### (6.7) Other Variations

Next, other variations will be enumerated one after another.

In the setting system 10A according to the present disclosure, the control device 1A includes a computer system. The computer system may include, as principal hardware components, a processor and a memory. The functions of the setting system 10A according to the present disclosure may be performed by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits include a system LSI, a very large-scale integrated circuit (VLSI), and an ultra-large-scale integrated circuit (ULSI). Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may he either integrated together on a single chip or distributed on multiple chips, whichever is appropriate. Those multiple chips may be integrated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a largescale integrated circuit.

Also, in the embodiment described above, the plurality of constituent elements (or the functions) of the setting system 10A are integrated together in a single housing. However, this is only an example and should not be construed as limiting. Alternatively, those constituent elements (or functions) of the setting system 10A may also be distributed in multiple different housings. Still alternatively, at least some functions of the setting system 10A (e.g., some functions of the control device 1A) may be implemented as a cloud computing system as well.

Conversely, in the second embodiment described above, at least some functions of the setting system 10A that are distributed in a plurality of devices may be aggregated together in a single housing. For example, some functions of the setting system 10A, which are distributed in the control device 1A and the display device 4A, may be aggregated together in a single housing.

In the second embodiment, the shooting range of the stage camera 22A is set to cover the tray 28 and the overall image 301 is shot in a single shooting session. Alternatively, the tray 28 may be shot separately as multiple images, which may be synthesized together to make the overall image 301.

Also, in the second embodiment described above, each indicator 311 has a rectangular frame shape. However, each indicator 311 does not have to have a rectangular shape but may also have a polygonal shape such as a hexagonal shape or a circular shape as well. Optionally, each indicator 311 may also have a honeycomb structure.

Furthermore, in the second embodiment described above, the respective indicators 311 have the same size. However, this is only an example and should not be construed as limiting. Alternatively, the respective indicators 311 may also have mutually different sizes.

Furthermore, in the second embodiment described above, when “custom tray” is selected on the selection window 303, the arrangement pattern of the indicators 311 may be selected from the group consisting of “grid,” “hound's tooth #1,” “hound's tooth #2,” and “full custom.” Alternatively, the arrangement pattern may be selected from a group including other options as well.

In the second embodiment described above, the control device 1A is implemented as a personal computer. However, this is only an example and should not be construed as limiting. Alternatively, the control device 1A may also be implemented as a tablet computer, a personal digital assistant (PDA), or a smartphone.

Furthermore, in the second embodiment described above, the number of rows or the number of columns is adjusted by operating the row plus buttons 312, the row minus buttons 313, the column plus buttons 314, and the column minus buttons 315. Alternatively, the number of rows and the number of columns may also be adjusted in the first entry field 3031 and the second entry field 3032 on the selection window 303.

### Recapitulation

As can be seen from the foregoing description, a setting system (10) according to a first aspect is designed for use in an appearance inspection machine (300) to inspect appearance of a plurality of targets (100; 100B). The setting system (10) includes an extraction unit (11), a calculation unit (12), and a presentation unit (4). The extraction unit (11) acquires a first difference between a non-defective product image, covering a non-defective product sample to be classified as a non-defective product among the plurality of targets (100; 100B), and a reference model. The extraction unit (11) also acquires a second difference between a defective product image, covering a defective product sample to be classified as a defective product among the plurality of targets (100; 100B), and the reference model. The extraction unit (11) extracts, as a potential defect (101-105; 106-109), either the first difference or the second difference, whichever satisfies a particular condition. The calculation unit (12) calculates at least one feature quantity (such as an area value) with respect to the potential defect (101-105; 106-109) extracted by the extraction unit (11). When the defective product sample includes a plurality of defective product samples and respective feature quantities of the potential defects extracted from the plurality of defective product samples have multiple different values, the calculation unit (12) specifies at least one of the feature quantities that has an N^{th} largest one (where N is a natural number) of the multiple different values as an indicator (I1). The presentation unit (4) presents the indicator (I1) specified by the calculation unit (12).

This aspect enables setting a decision threshold value suitably applicable to appearance inspection for high-mix low-volume production.

A setting system (10) according to a second aspect, which may be implemented in conjunction with the first aspect, further includes an input acceptance unit (21). The input acceptance unit (21) accepts a decision threshold value entered by a user based on the indicator (I1) presented by the presentation unit (4).

This aspect enables setting a decision threshold value based on the input from the user.

A setting system (10) according to a third aspect, which may be implemented in conjunction with the second aspect, further includes a go/no-go decision unit (13). The go/no-go decision unit (13) determines a given one of the plurality of targets (100; 100B) to be the non-defective product when finding the feature quantity of the potential defect (101-105; 106-109) falling within a decision range (R1) and determines the given target to be the defective product when finding the feature quantity of the potential defect (101-105; 106-109) falling outside of the decision range (R1). The decision range (R1) is to be specified by the decision threshold value accepted by the input acceptance unit (21).

This aspect enables making a go/no-go decision on the target (100; 100B) by determining whether or not the feature quantity falls within the decision range (R1).

In a setting system (10) according to a fourth aspect, which may be implemented in conjunction with the third aspect, when the decision threshold value is defined as a first decision threshold value and the decision range (R1) is defined as a first decision range (R1), the go/no-go decision unit (13) determines, when finding, with respect to a given one of the plurality of targets (100; 100B), the feature quantity of the potential defect (101-105; 106-109) falling within a second decision range (R2), the given target to be a product to be reinspected. The second decision range (R2) is specified by the first decision threshold value and a second decision threshold value that has been accepted by the input acceptance unit (21) and is different from the first decision range (R1).

This aspect requires the user to inspect, with the naked eye, only the target (100; 100B) that has been determined to be a product to be reinspected, thus lightening the inspection burden on the user.

A setting system (10) according to a fifth aspect, which may he implemented in conjunction with any one of the first to fourth aspects, further includes an image capturing unit (3). The image capturing unit (3) captures the non-defective product image and the defective product image.

This aspect enables capturing a non-defective product image and a defective product image.

In a setting system (10) according to a sixth aspect, which may be implemented in conjunction with any one of the first to fifth aspects, the presentation unit (4) presents the potential defect of the non-defective product sample and the potential defect of the defective product sample distinguishably from each other.

This aspect achieves the advantage of making it easier to distinguish the potential defect of the non-defective product sample and the potential defect of the defective product sample from each other.

A setting system (10) according to a seventh aspect, which may be implemented in conjunction with any one of the first to sixth aspects, further includes a borderline defect selecting unit (23). The borderline defect selecting unit (23) selects, from the potential defects of the defective product samples, a borderline defect (110) that allows the defective product sample to be determined to be the defective product. The presentation unit (4) further presents at least one feature quantity of the borderline defect (110) selected by the borderline defect selecting unit (23).

This aspect enables improving the accuracy of the go/no-go decision by setting the decision threshold value such that the decision threshold value does not include the borderline defect (110).

In a setting system (10) according to an eighth aspect, which may be implemented in conjunction with any one of the first to seventh aspects, the presentation unit (4) presents, as a graph, the respective feature quantities of the potential defects (101-105; 106-109).

This aspect achieves the advantage of facilitating setting the decision threshold value.

In a setting system (10) according to a ninth aspect, which may be implemented in conjunction with any one of the first to eighth aspects, the calculation unit (12) calculates two or more feature quantities, one of which is the feature quantity, with respect to the potential defect (101-105; 106-109) extracted by the extraction unit (11).

This aspect enables improving the decision accuracy compared to a situation where only one feature quantity is calculated.

A setting method according to a tenth aspect is applicable to an appearance inspection machine (300) to inspect appearance of a plurality of targets (100; 100B). The selling method includes an extraction step (ST14), a calculation step (ST15), and a presentation step (ST16). The extraction step (ST14) includes acquiring a first difference between a non-defective product image, covering a non-defective product sample to be classified as a non-defective product among the plurality of targets (100; 100B), and a reference model. The extraction step (ST14) also includes acquiring a second difference between a defective product image, covering a defective product sample to be classified as a defective product among the plurality of targets (100; 100B), and the reference model. The extraction step (ST14) further includes extracting, as a potential defect (101-105; 106-109), either the first difference or the second difference, whichever satisfies a particular condition. The calculation step (ST15) includes calculating at least one feature quantity with respect to the potential defect (101-105; 106-109) extracted in the extraction step (ST14). The calculation step (ST15) includes specifying, when the defective product sample includes a plurality of defective product samples and respective feature quantities of the potential defects extracted from the plurality of defective product samples have multiple different values, at least one of the feature quantities that has an N^{th} largest one (where N is a natural number) of the multiple different values as an indicator (I1). The presentation step (ST16) includes presenting the indicator (I1) specified in the calculation step (ST15).

This aspect enables setting a decision threshold value suitably applicable to appearance inspection for high-mix low-volume production.

A program according to an eleventh aspect is designed to cause one or more processors to perform the setting method according to the tenth aspect.

This aspect enables setting a decision threshold value suitably applicable to appearance inspection for high-mix low-volume production.

Note that the constituent elements according to the second to ninth aspects are not essential constituent elements for the setting system (10) but may be omitted as appropriate.

A setting system (10A) according to a twelfth aspect is designed for use in an appearance inspection machine (300A) to perform appearance inspection on an object under test (B1) falling within an inspection area (A1) based on an inspection image (302) covering the inspection area (A1). The setting system (10A) is configured to make settings of the inspection area (A1) on a settings window (30) displayed on a display unit (4A). The settings window (30) includes an overall image (301) covering a plurality of inspection areas (A1) and an indicator (311) superimposed on the overall image (301). The setting system (10A) includes a registration unit (11A). The registration unit (11A) registers the plurality of inspection areas (A1) according to location of the indicator (311) on the settings window (30).

This aspect enables making settings of the inspection area (A1) suitable for general-purpose appearance inspection.

In a setting system (10A) according to a thirteenth aspect, which may be implemented in conjunction with the twelfth aspect, at least one of the location, size, orientation, or shape of the indicator (311) is changeable on the settings window (30) in accordance with a command entered by a user.

This aspect enables changing the location or other parameters of the indicator (311) in accordance with the user's command.

In a setting system (10A) according to a fourteenth aspect, which may be implemented in conjunction with the twelfth or thirteenth aspect, the settings window (30) further includes an inspection image (302) covering an inspection area (A1) selected from a plurality of inspection areas (A1) included in the overall image (301). In the setting system (10), the inspection area (A1) registered may be corrected based on the inspection image (302) included in the settings window (30).

This aspect enables correcting the inspection area (A1).

In a setting system (10A) according to a fifteenth aspect, which may be implemented in conjunction with any one of the twelfth to fourteenth aspects, the indicator (311) includes a frame-shaped object that surrounds each of the plurality of inspection areas (A1).

This aspect achieves the advantage of facilitating setting the inspection area (A1).

In a setting system (10A) according to a sixteenth aspect, which may be implemented in conjunction with any one of the twelfth to fifteenth aspects, a plurality of indicators (311) corresponding to the plurality of inspection areas (A1) are displayed collectively as a group of indicators (31).

This aspect enables setting the plurality of inspection areas (A1) collectively.

In a setting system (10A) according to a seventeenth aspect, which may be implemented in conjunction with the sixteenth aspect, the plurality of indicators (311) included in the group of indicators (31) are arranged regularly.

This aspect achieves the advantage of making the correspondence between the inspection areas (A1) and the indicators (311) easily understandable.

In a setting system (10A) according to an eighteenth aspect, which may be implemented in conjunction with the sixteenth or seventeenth aspect, the plurality of indicators (311) included in the group of indicators (31) are readily increased or decreased on a row-by-row basis and/or on a column-by-column basis.

This aspect enables easily increasing or decreasing the plurality of indicators (311).

In a setting system (10A) according to a nineteenth aspect, which may be implemented in conjunction with any one of the sixteenth to eighteenth aspects, an arrangement pattern of the plurality of indicators (311) included in the group of indicators (31) is selectable from a plurality of selectable patterns.

According to this aspect, an arrangement pattern just needs to be selected from the plurality of selectable patterns, thus achieving the advantage of improving the work efficiency.

A setting system (10A) according to a twentieth aspect, which may be implemented in conjunction with any one of the twelfth to nineteenth aspects, has an input support function to support input of the indicator (311).

This aspect achieves the advantage of facilitating inputting the indicator (311).

In a setting system (10A) according to a twenty-first aspect, which may be implemented in conjunction with any one of the twelfth to twentieth aspects, the appearance inspection machine (300A) displays, when a particular inspection area (A1) is selected among the plurality of inspection areas (A1) in a wide-angle image corresponding to the overall image (301), an image of the inspection area (A1) selected.

This aspect enables displaying an image of an inspection area (A1) selected from a wide-angle image.

A setting system (10A) according to a twenty-second aspect, which may be implemented in conjunction with any one of the twelfth to twenty-first aspects, has the capability of making calibration with respect to a. first shooting unit (22) that captures the overall image (301) and a second shooting unit (23) that captures the inspection image (302).

This aspect enables correcting relative positions of the first shooting unit (22) and the second shooting unit (23).

In a setting system (10A) according to a twenty-third aspect, which may be implemented in conjunction with the twenty-second aspect, a field of view frame (3063) representing a field of view of the second shooting unit (23) is displayed on the overall image (301).

This aspect enables displaying the field of view of the second shooting unit (23) on the overall image (301).

In a setting system (10A) according to a twenty-fourth aspect, which may be implemented in conjunction with any one of the twelfth to twenty-third aspects, the objects under test (B1) are held in a plurality of holding spaces (281), respectively corresponding to the plurality of inspection areas (A1), of a tray (28).

This aspect enables setting the inspection area (A1) by making the indicator (311) point to any of the holding spaces (281) of the tray (28).

An appearance inspection machine (300A) according to a twenty-fifth aspect includes the setting system (10A) according to any one of the twelfth to twenty-fourth aspects.

This aspect enables making settings of the inspection area (A1) suitable for general-purpose appearance inspection.

In an appearance inspection machine (300A) according to a twenty-sixth aspect, which may be implemented in conjunction with the twenty-fifth aspect, an object under test (B1) that has been determined to be a defective product by appearance inspection is displayed in a display region (R1) to be distinguished from an object under test (B1) that has been determined to be a non-defective product by appearance inspection.

This aspect enables displaying a defective product distinguishably from a non-defective product.

A setting method according to a twenty-seventh aspect is method applicable to an appearance inspection machine (300A) to perform appearance inspection on an object under test (B1) falling within an inspection area (A1) based on an inspection image (302) covering the inspection area (A1). The setting method includes making settings of the inspection area (A1) on a settings window (30) displayed on a display unit (4A). The settings window (30) includes an overall image (301) covering a plurality of inspection areas (A1) and an indicator (311) superimposed on the overall image (301). The setting method includes a registration step. The registration step includes registering the plurality of inspection areas (A1) according to location of the indicator (311) on the settings window (30).

This aspect enables making settings of the inspection area (A1) suitable for general-purpose appearance inspection.

A program according to a twenty-eighth aspect is applicable to a setting system (10A) for use in an appearance inspection machine (300A) to perform appearance inspection on an object under test (B1) falling within an inspection area (A1) based on an inspection image (302) covering the inspection area (A1). The setting system (10A) is configured to make settings of the inspection area (A1) on a settings window (30) displayed on a display unit (4A). The settings window (30) includes an overall image (301) covering a plurality of inspection areas (A1) and an indicator (311) superimposed on the overall image (301). The program is designed to cause one or more processors for use in the setting system (10A) to serve as a registration unit (11A). The registration unit (11A) registers the plurality of inspection areas (A1) according to location of the indicator (311) on the settings window (30).

This aspect enables making settings of the inspection area (A1) suitable for general-purpose appearance inspection.

### REFERENCE SIGNS LIST

3 Image Capture Device (Image Capturing Unit)
4 Display Device (Presentation Unit)
10 Setting System
11 Extraction Unit
12 Calculation Unit
13 Go/No-Go Decision Unit
21 Input Acceptance Unit
23 Borderline Defect Selecting Unit
300 Appearance Inspection Machine
100, 100B Target
101-109 Potential Defect
110 Borderline Defect
I1 Indicator
R1 First Decision Range (Decision Range)
R2 Second Decision Range
ST14 Extraction Step
ST15 Calculation Step
ST16 Presentation Step

1. A setting system for use in an appearance inspection machine configured to inspect appearance of a plurality of targets, the setting system comprising:
an extraction unit configured to acquire a first difference and a second difference and extract, as a potential defect, either the first difference or the second difference, whichever satisfies a particular condition, the first difference being a difference between a non-defective product image, covering a non-defective product sample to be classified as a non-defective product among the plurality of targets, and a reference model, the second difference being a difference between a defective product image, covering a defective product sample to be classified as a defective product among the plurality of targets, and the reference model;
a calculation unit configured to calculate at least one feature quantity with respect to the potential defect extracted by the extraction unit, the calculation unit being configured to, when the defective product sample includes a plurality of defective product samples and respective feature quantities of the potential defects extracted from the plurality of defective product samples have multiple different values, specify at least one of the feature quantities that has an Nth largest one of the multiple different values as an indicator, where N is a natural number; and
a presentation unit configured to present the indicator specified by the calculation unit.

2. The setting system of claim 1, further comprising an input acceptance unit configured to accept a decision threshold value entered by a user based on the indicator presented by the presentation unit.

3. The setting system of claim 2, further comprising a go/no-go decision unit configured to determine a given one of the plurality of targets to be the non-defective product when finding the feature quantity of the potential defect falling within a decision range to be specified by the decision threshold value accepted by the input acceptance unit and determine the given target to be the defective product when finding the feature quantity of the potential defect falling outside of the decision range.

4. The setting system of claim 3, wherein
when the decision threshold value is defined as a first decision threshold value and the decision range is defined as a first decision range,
the go/no-go decision unit is configured to, when finding, with respect to a given one of the plurality of targets, the feature quantity of the potential defect falling within a second decision range, determine the given target to be a product to be reinspected, the second decision range being different from the first decision range and specified by the first decision threshold value and a second decision threshold value, the second decision threshold value having been accepted by the input acceptance unit and being different from the first decision threshold value.

5. The setting system of claim 1, further comprising an image capturing unit configured to capture the non-defective product image and the defective product image.

6. The setting system of claim 1, wherein
the presentation unit is configured to present the potential defect of the non-defective product sample and the potential defect of the defective product sample distinguishably from each other.

7. The setting system of claim 1, further comprising a borderline defect selecting unit configured to select, from the potential defects of the defective product samples, a borderline defect that allows the defective product sample to be determined to be the defective product, wherein
the presentation unit is configured to further present the feature quantity of the borderline defect selected by the borderline defect selecting unit.

8. The setting system of claim 1, wherein
the presentation unit is configured to present, as a graph, the respective feature quantities of the potential defects.

9. The setting system of claim 1, wherein
the calculation unit is configured to calculate two or more feature quantities, one of which is the feature quantity, with respect to the potential defect extracted by the extraction unit.

10. A setting method applicable to an appearance inspection machine configured to inspect appearance of a plurality of targets, the setting method comprising:
an extraction step including acquiring a first difference and a second difference and extracting, as a potential defect, either the first difference or the second difference, whichever satisfies a particular condition, the first difference being a difference between a non-defective product image, covering a non-defective product sample to be classified as a non-defective product among the plurality of targets, and a reference model, the second difference being a difference between a defective product image, covering a defective product sample to be classified as a defective product among the plurality of targets, and the reference model;
a calculation step including calculating at least one feature quantity with respect to the potential defect extracted in the extraction step, the calculation step including specifying, when the defective product sample includes a plurality of defective product samples and respective feature quantities of the potential defects extracted from the plurality of defective product samples have multiple different values, at least one of the feature quantities that has an Nth largest one of the multiple different values as an indicator, where N is a natural number; and
a presentation step including presenting the indicator specified in the calculation step.

11. A non-transitory computer-readable tangible recording medium storing a program designed to cause one or more processors to perform the setting method of claim 10.
